(19) United States
(12) Patent Application Publication
(10) Pub. No.: US 2026/0340666 A1
(43) Pub. Date: Oct. 29, 2026

(54) SYSTEM AND METHOD FOR DRY CLEANING/LAUNDRY LOGISTICS

(71) Applicant: Juliette Inc., New York, NY (US)

(72) Inventor: Rechelle Balanzat, New York, NY (US)

(73) Assignee: Juliette Inc., New York, NY (US)

(21) Appl. No.: 19/415,816

(22) Filed: Dec. 11, 2025

Related U.S. Application Data
(63) Continuation-in-part of application No. 18/109,903, filed on Feb. 15, 2023, now abandoned.

(51) Int. Cl. G06Q 30/0202; G06Q 40/12; H04L 9/40

(52) U.S. Cl. CPC G06Q 30/0202; G06Q 40/12; H04L 63/0838

(57) ABSTRACT

A computer program may provide, using a graphical user interface of a computing device, a dashboard to a user. A computer program may display, using the graphical user interface, at least one data point having a laundry management logistic timestamp associated with data. A computer program may be configured for the user inputting, using the graphic user interface, the data from the at least one data point. A computer program may process the data from at least one data point. A computer program may analyze, using the computer program, the data having the timestamp. A computer program may be responsive to analyzing, using the computer program, to identify a sequence of laundry order information from the data having the timestamp. A computer program may execute the computer program on the sequence of the laundry order information, wherein the computer program predicting a trend associated with the laundry order information.

### CROSS-REFERENCE TO RELATED APPLICATIONS

This application is a U.S. Continuation-In-Part Utility Patent Application entitled, “SYSTEM AND METHOD FOR DRY CLEANING/LAUNDRY LOGISTICS” which claims priority to U.S. non-provisional utility patent application Ser. No. 18/109,903, filed on Feb. 15, 2023 entitled, “SYSTEM AND METHOD FOR DRY CLEANING/LAUNDRY LOGISTICS” the contents of which are hereby fully incorporated by reference.

### FIELD OF THE EMBODIMENTS

The field of the invention and its embodiments relates to systems and methods for dry cleaning and laundry logistics, and more particularly to a computer program having a business intelligence dashboard configured for point of sale management and logistics.

### BACKGROUND OF THE EMBODIMENTS

Currently, many laundry and dry cleaning businesses manage order intake manually, which may be prone to human error. Customer details and preferences of customers are typically kept on notepads and stored in file cabinets, which makes manual searching of a customer's file time consuming. There is a wealth of customer data as it pertains to dry cleaning and laundry point of sale that is not being analyzed for optimal order tracking and/or management to facilitate customized customer experience and marketing, assembly and production management, and staff management and visibility. For example, some companies count the number of pounds of laundry washed and the number of pieces of garments dry cleaned. It would be more desirable to use this collected data to make informed business decisions. For example, determining projected ranges of pounds of clothes a business can expect to wash in a given time period may be used for a more accurate cleaning agent inventory control. In another example, a business could determine projected revenue from a select grouping of customers and plan for potential expenses accordingly.

Thus, there is a need for a historical data analysis system and method that may facilitate dry cleaning and/or laundry businesses to make more accurate projections by analyzing business trends as a whole as well as tracking day-to-day business in order to assess future plans of action.

### REVIEW OF RELATED ART

JP2020074132A is a reference providing a laundry management system that includes a POS terminal, a shop mobile terminal and a management device.

TW201344600A is a reference providing a system and a method for laundry management and delivery.

CN113313398B is a reference describing a laundry management method and system that allows users to receive real-time notifications regarding the status of their laundry and/or dry cleaning.

WO2020130572A1 and US20220141628A1 references describe a method for providing a non-contact laundry service. The method includes numerous process steps, such as: executing a non-contact laundry service application; receiving the input, from a user, of a tariff system of a non-contact laundry service; fastening to the user's door a laundry bag, for a non-contact laundry service, into which the user puts laundry; and the user requesting a pick-up using a pick-up request button on the application.

SUMMARY OF THE EMBODIMENTS

The present invention and its embodiments relate to a software solution for laundry and dry cleaning. In some aspects, the techniques described herein relate to a laundry and dry cleaning system having a point of sale data manager, a logistics platform, and a business intelligence dashboard for data analysis and projection model generation.

In some aspects, the techniques described herein relate to a computer program including instructions which, when the program is executed by a computer, cause the computer to carry out the steps of: providing, using a graphical user interface of a computing device, a dashboard to a user, displaying, using the graphical user interface, at least one data point having a laundry management logistic timestamp associated with data of an order; inputting by the user, using the graphical user interface, the data from the at least one data point; processing the data from the at least one data point; analyzing the data having the timestamp, using machine learning, to generate a sequence of laundry order information including timestamped laundry order data; identifying, responsive to the analyzing, a predetermined portion of the timestamped laundry order data, the predetermined portion including a machine selected subset of the sequence that satisfies one or more selection criteria including a defined time window of recent timestamped laundry order data and a minimum quantity of records; executing, by the computer, a model inference operation of the computer program using the predetermined portion of the timestamped laundry order data, wherein executing the computer program on the predetermined portion includes applying a trained machine learning model to the predetermined portion to generate predicted trends; ; providing, using the graphical user interface of the computing device, a third-party sign-up module including a software based registration interface rendered within the graphical user interface, wherein the registration interface includes programmatic elements configured to collect user account information; collecting, at the third-party sign-up module, one or more personal details of the user including at least a full name, an email address, and a password entered into user input fields of the registration interface; receiving and verifying, at the third-party sign-up module, a mobile number of the user by generating a one-time password (OTP), storing the OTP in an OTP log maintained within a memory of the computing device or a server side storage system associated with the computing device, transmitting the OTP to the mobile number, and resending the OTP upon user request; and creating and updating a timestamp for client data stored in a client account record, wherein the client data includes at least personal details, address details, and payment card information collected and saved by the third-party sign-up module.

In some aspects, the techniques described herein relate to a computer-implemented method including: providing, using a graphical user interface of a computing device, a dashboard to a user; displaying, using the graphical user interface, at least one data point having a dry cleaning management logistic timestamp associated with data of an order; inputting by a user, using the graphic user interface, the data from the at least one data point; processing the data from the at least one data point; analyzing the data having the timestamp, using machine learning, to generate a sequence of laundry order information including timestamped laundry order data; identifying, responsive to the analyzing, a predetermined portion of the timestamped laundry order data, the predetermined portion including a machine selected subset of the sequence that satisfies one or more selection criteria including a defined time window of recent timestamped laundry order data and a minimum quantity of records; executing, by the computer, a model inference operation of a computer program using the predetermined portion of the timestamped laundry order data, wherein executing the computer program on the predetermined portion includes applying a trained machine learning model to the predetermined portion to generate predicted trends; providing, using the graphical user interface of the computing device, a third-party sign-up module including a software based registration interface rendered within the graphical user interface, wherein the registration interface includes programmatic elements configured to collect user account information; collecting, at the third-party sign-up module, one or more personal details of the user including at least a full name, an email address, and a password entered into user input fields of the registration interface; receiving and verifying, at the third-party sign-up module, a mobile number of the user by generating a one-time password (OTP), storing the OTP in an OTP log maintained within a memory of the computing device or a server side storage system associated with the computing device, transmitting the OTP to the mobile number, and resending the OTP upon user request; and creating and updating a timestamp for client data stored in a client account record, wherein the client data includes at least personal details, address details, and payment card information collected and saved by the third-party sign-up module.

### BRIEF DESCRIPTION OF THE DRAWINGS

FIG. 1 depicts a flow chart illustrating a customer dashboard for a system and method for dry cleaning and/or laundry logistics, according to at least some embodiments disclosed herein;

FIG. 2 depicts an illustration of a block diagram of an embodiment of a customer dashboard for a system and method for dry cleaning and/or laundry logistics system of FIG. 1, according to at least some embodiments disclosed herein;

FIG. 3 depicts a flow chart illustrating customer details for a system and method for dry cleaning and/or laundry logistics, according to at least some embodiments disclosed herein;

FIG. 4 depicts an illustration of a block diagram of an embodiment of customer details for a system and method for dry cleaning and/or laundry logistics of FIG. 3, according to at least some embodiments disclosed herein;

FIG. 5 depicts a flow chart illustrating editing customer details for a system and method for dry cleaning and/or laundry logistics, according to at least some embodiments disclosed herein;

FIG. 6 depicts an illustration of a block diagram of an embodiment of editing customer details for a system and method for dry cleaning and/or laundry logistics of FIG. 5, according to at least some embodiments disclosed herein;

FIG. 7 depicts a flow chart illustrating order history details for a system and method for dry cleaning and/or laundry logistics, according to at least some embodiments disclosed herein;

FIG. 8 depicts an illustration of a block diagram of an embodiment of order history details for a system and method for dry cleaning and/or laundry logistics of FIG. 7, according to at least some embodiments disclosed herein;

FIG. 9 depicts a flow chart illustrating analytics for a system and method for dry cleaning and/or laundry logistics, according to at least some embodiments disclosed herein;

FIG. 10 depicts a flow chart illustrating analytics for a system and method for dry cleaning and/or laundry logistics, according to at least some embodiments disclosed herein;

FIG. 11 depicts an illustration of a block diagram of an embodiment of adding an order for a system and method for dry cleaning and/or laundry logistics of FIG. 9, according to at least some embodiments disclosed herein;

FIG. 12 depicts a flow chart illustrating a pre-orders dashboard and adding a pre-order for a system and method for dry cleaning and/or laundry logistics, according to at least some embodiments disclosed herein;

FIG. 13 depicts an illustration of a block diagram of an embodiment of a pre-order dashboard for a system and method for dry cleaning and/or laundry logistics of FIG. 12, according to at least some embodiments disclosed herein;

FIG. 14 depicts an illustration of a block diagram of an embodiment of adding a pre-order for a system and method for dry cleaning and/or laundry logistics of FIG. 12, according to at least some embodiments disclosed herein;

FIG. 15 depicts a flow chart illustrating an orders dashboard and adding a pre-order for a system and method for dry cleaning and/or laundry logistics, according to at least some embodiments disclosed herein,

FIG. 16 depicts an illustration of a block diagram of an embodiment of a module for stages of an order for a system and method for dry cleaning and/or laundry logistics of FIG. 15, according to at least some embodiments disclosed herein;

FIG. 17 depicts a flow chart illustrating a draft order dashboard for a system and method for dry cleaning and/or laundry logistics, according to at least some embodiments disclosed herein;

FIG. 18 depicts a flow chart illustrating a discounts dashboard for a system and method for dry cleaning and/or laundry logistics, according to at least some embodiments disclosed herein;

FIG. 19 depicts a flow chart illustrating adding orders in an order intake dashboard for a system and method for dry cleaning and/or laundry logistics, according to at least some embodiments disclosed herein;

FIG. 20 depicts an illustration of a block diagram of an embodiment of adding orders in an order intake dashboard for a system and method for dry cleaning and/or laundry logistics of FIG. 19, according to at least some embodiments disclosed herein;

FIG. 21 depicts an illustration of a block diagram of an embodiment of an order details module for a system and method for dry cleaning and/or laundry logistics, according to at least some embodiments disclosed herein;

FIG. 22 depicts a flow chart illustrating an items module for a system and method for dry cleaning and/or laundry logistics, according to at least some embodiments disclosed herein;

FIG. 23 depicts an illustration of a block diagram of an embodiment of an items module for a system and method for dry cleaning and/or laundry logistics of FIG. 22, according to at least some embodiments disclosed herein;

FIG. 24 depicts an illustration of a block diagram of an embodiment of an items module having the ability to add an item for a system and method for dry cleaning and/or laundry logistics, according to at least some embodiments disclosed herein;

FIG. 25 depicts an illustration of a block diagram of an embodiment of an items module having the ability to edit an item for a system and method for dry cleaning and/or laundry logistics, according to at least some embodiments disclosed herein;

FIG. 26 depicts a flow chart illustrating an add-ons module for a system and method for dry cleaning and/or laundry logistics, according to at least some embodiments disclosed herein;

FIG. 27 depicts a flow chart illustrating a discounts dashboard for a system and method for dry cleaning and/or laundry logistics, according to at least some embodiments disclosed herein;

FIG. 28 depicts a flow chart illustrating a cash flow module for a system and method for dry cleaning and/or laundry logistics, according to at least some embodiments disclosed herein;

FIG. 29 depicts a flow chart illustrating an embodiment of for a cash flow module for a system and method for dry cleaning and/or laundry logistics, according to at least some embodiments disclosed herein;

FIG. 30 depicts a flow chart illustrating a cash register configured to edit a cash entry for a system and method for dry cleaning and/or laundry logistics, according to at least some embodiments disclosed herein,

FIG. 31 depicts a flow chart illustrating an embodiment of a cash register configured to add a cash entry for a system and method for dry cleaning and/or laundry logistics, according to at least some embodiments disclosed herein;

FIG. 32 depicts a flow chart illustrating a module showing a vendor listing for a system and method for dry cleaning and/or laundry logistics, according to at least some embodiments disclosed herein;

FIG. 33 depicts a flow chart illustrating a third party sign-up module for a system and method for dry cleaning and/or laundry logistics, according to at least some embodiments disclosed herein;

FIG. 34 depicts an illustration of a block diagram of an embodiment for a third party sign-up module for a system and method for dry cleaning and/or laundry logistics of FIG. 33, according to at least some embodiments disclosed herein;

FIG. 35 depicts an illustration of a block diagram of an embodiment for a third party sign-up module for a system and method for dry cleaning and/or laundry logistics, according to at least some embodiments disclosed herein;

FIG. 36 depicts a flow chart illustrating a third party login module for a system and method for dry cleaning and/or laundry logistics, according to at least some embodiments disclosed herein;

FIG. 37 depicts an illustration of a block diagram of an embodiment for a third party sign-login module for a system and method for dry cleaning and/or laundry logistics of FIG. 36, according to at least some embodiments disclosed herein;

FIG. 38 depicts an illustration of a block diagram of a forget password module for a system and method for dry cleaning and/or laundry logistics, according to at least some embodiments disclosed herein;

FIG. 39 depicts an illustration of a block diagram of an embodiment for a forget password module for a system and method for dry cleaning and/or laundry logistics, according to at least some embodiments disclosed herein;

FIG. 40 depicts a flow chart illustrating a request pickup module for a system and method for dry cleaning and/or laundry logistics, according to at least some embodiments disclosed herein;

FIG. 41 depicts an illustration of a block diagram of an embodiment for a request pickup module for a system and method for dry cleaning and/or laundry logistics of FIG. 40, according to at least some embodiments disclosed herein;

FIG. 42 depicts an illustration of a block diagram of an embodiment for a cancel pickup module for a system and method for dry cleaning and/or laundry logistics, according to at least some embodiments disclosed herein;

FIG. 43 depicts a flow chart illustrating a view orders module for a system and method for dry cleaning and/or laundry logistics, according to at least some embodiments disclosed herein;

FIG. 44 depicts an illustration of a block diagram of an embodiment for a view orders module for a system and method for dry cleaning and/or laundry logistics of FIG. 43, according to at least some embodiments disclosed herein;

FIG. 45 depicts a flow chart illustrating a profile module for a system and method for dry cleaning and/or laundry logistics, according to at least some embodiments disclosed herein;

FIG. 46 depicts an illustration of a block diagram of an embodiment for a profile module for a system and method for dry cleaning and/or laundry logistics of FIG. 45, according to at least some embodiments disclosed herein;

FIG. 47 depicts an illustration of a block diagram of an embodiment for adding address details to a profile module for a system and method for dry cleaning and/or laundry logistics, according to at least some embodiments disclosed herein;

FIG. 48 depicts an illustration of a block diagram of an embodiment for adding card payment details to a profile module for a system and method for dry cleaning and/or laundry logistics, according to at least some embodiments disclosed herein;

FIG. 49 depicts an illustration of a block diagram of an embodiment for editing personal details in a profile module for a system and method for dry cleaning and/or laundry logistics, according to at least some embodiments disclosed herein;

FIG. 50 depicts an illustration of a block diagram of an embodiment for editing address details in a profile module for a system and method for dry cleaning and/or laundry logistics, according to at least some embodiments disclosed herein;

FIG. 51 depicts an illustration of a block diagram of an embodiment for editing password details in a profile module for a system and method for dry cleaning and/or laundry logistics, according to at least some embodiments disclosed herein;

FIG. 52 depicts an illustration of a block diagram of an embodiment for editing email details in a profile module for a system and method for dry cleaning and/or laundry logistics, according to at least some embodiments disclosed herein;

FIG. 53 depicts an illustration of a block diagram of an embodiment for editing mobile number details to a profile module for a system and method for dry cleaning and/or laundry logistics, according to at least some embodiments disclosed herein;

FIG. 54 depicts an illustration of a block diagram of an embodiment accessing price list data for a system and method for dry cleaning and/or laundry logistics, according to at least some embodiments disclosed herein;

FIG. 55 depicts an illustration of a block diagram of an embodiment accessing informative data for a system and method for dry cleaning and/or laundry logistics, according to at least some embodiments disclosed herein;

FIG. 56 depicts a flow chart illustrating a method for dry cleaning and/or laundry logistic generation;

FIG. 57 is a block diagram illustrating a computer program, according to some embodiments of the present disclosure;

FIG. 58A is a flowchart illustrating a computer-implemented method, according to some embodiments of the present disclosure;

FIG. 58B is a flowchart extending from FIG. 58A and further illustrating the computer-implemented method, according to some embodiments of the present disclosure; and

FIG. 59 is a flowchart further illustrating the computer-implemented method from FIG. 58A, according to some embodiments of the present disclosure.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

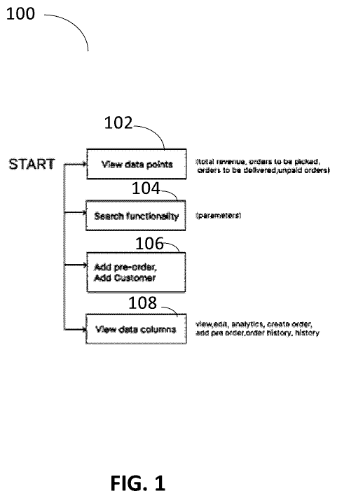

FIG. 1 depicts a flow chart illustrating a customer dashboard 100 for a system and method for dry cleaning and/or laundry logistics where cards are shown at the top of the dashboard. At 102, view data points 102 includes, but is not limited to, total revenue, orders to be picked up, orders to be delivered, and/or unpaid orders. At 104, search functionality 104 includes parameters. The columns are shown on the dashboard including, but not limited to, profile, first name, last name, mobile, email address, last four credit card digits, total sales, and latest order. Search functionality is based on all the columns shown in the dashboard. In an example a search may be made with a name and/or a date. Data may be filtered based on the columns shown on the dashboard. Data may also be filtered based on date range. At 106, pre-order data may be added and/or customer information may be added. At 108, viewing data columns provide actions possible from the dashboard including, but not limited to, view, edit, analytics, create order, add pre order, order history, and delete.

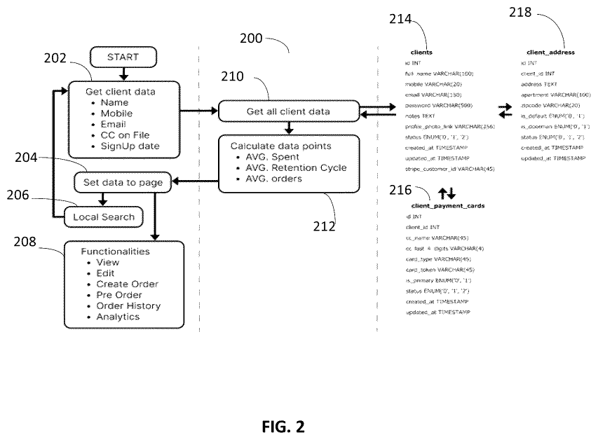

FIG. 2 depicts an illustration of a block diagram of an embodiment of customer dashboard 200 for a system and method for dry cleaning and/or laundry logistics system of FIG. 1. At 202, client data is received. It is within the scope of this invention for client data to include, but not be limited to name, mobile number, email, credit card on file, and/or sign-up date. At 210, all client data is received. At 212, data points are calculated based on the average amount spent, average retention cycle, and/or average order. At 204, set data to page. At 206, a local search may be performed. At 208, functionalities include, but are not limited to, view, edit, create order, pre-order, order history, and/or analytics. At 214, the creation of new and/or updated data of client information is timestamped. At 216, the creation of new and/or updated data of client card payments is timestamped. At 218, the creation of new and/or updated data of the client address is timestamped.

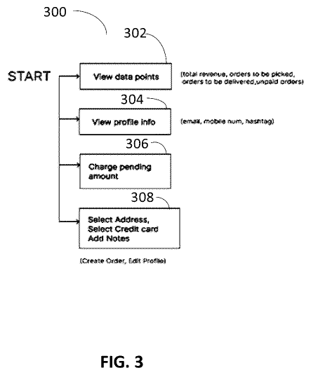

FIG. 3 depicts a flow chart illustrating customer details for a system and method for dry cleaning and/or laundry logistics, according to embodiment 300 disclosed herein. At 302, viewing data points includes, but is not limited to, total revenue, orders to be picked-up, orders to be delivered, and/or unpaid orders. A listing of API's is needed to retrieve data points for the page such as, a profile image, total orders, total amount, average order price, full name, email address, mobile number, tag, list of address when the default is preselected, a list of credit cards when the default is preselected, and/or notes. At 304, viewing profile information includes, but is not limited to, email, mobile, and/or hashtag. At 306, the pending amount is charged. The total amount pending is shown to a customer. When a user clicks on the charge icon, a payment alert box opens and a user proceeds with processing a payment. At 308, to create an order and/or edit the profile, an address may be selected, a credit card may be selected, and/or notes may be added. Search functionality is based on all the columns shown in the dashboard and may be used to search the customer data. It is within the scope of this invention for at least 20% of the screen to show a list of customers. A list of customers will display a customer first name, last name, and/or profile. The actions made possible from this page include, but are not limited to, navigating back to the customers list and/or creating an order.

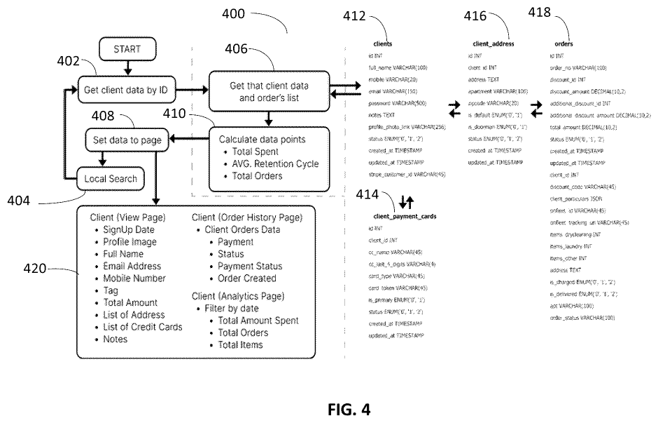

FIG. 4 depicts an illustration of a block diagram of embodiment 400 of customer details for a system and method for dry cleaning and/or laundry logistics of FIG. 3. At 402, client data is retrieved by ID. At 406, the client data and order's list is retrieved. At 410, data points are calculated such as the total spent, average retention cycle, and/or total orders. At 408, data is set to a page. At 404, a local search may be performed to retrieve client data by ID. At 420, a client view page shows information including, but not limited to, sign-up date, a profile image, full name, email address, mobile number, a tag, a total amount, a list of addresses, a list of credit cards, and/or notes. A client order history page displays client orders data including, but not limited to, payment, status, payment status, and/or order created. A client analytics page displays information filtered by date such as the total amount spent, the total orders, and/or total items. At 412, client information is created and updated with a timestamp. At 414, client payment card information is created and updated with a timestamp. At 416, client address information is created and updated with a timestamp. At 418, order information is created and updated with a timestamp.

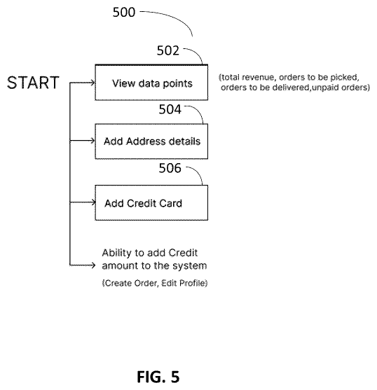

FIG. 5 depicts a flow chart illustrating editing customer details for a system and method for dry cleaning and/or laundry logistics, according to embodiment 500 disclosed herein. At 502, a list of API's are needed to edit data points for this page such as, total revenue, orders to be picked-up, orders to be delivered, and/or unpaid orders. A list of API's include, but are not limited to, a profile image, a first name, a last name, a mobile number, an email address, a tag, notes, an address selection, a credit card selection, and/or a total credit. At 504, the ability for a user to add a new address when an icon is selected next to the address field of the user interface. An alert message will be displayed to a user through the user interface showing details including, but not limited to, apartment number, zip code, address, and/or set as default checkbox. At 506, the ability for a user to add a new credit card when an icon is selected next to the credit card field. An alert message will be displayed to a user through the user interface showing details including, but not limited to, name on the card, card number, expiration number, CVV, and/or set as default checkbox. An ability for the system to charge a user for the outstanding balance due is accomplished by displaying the total amount pending for a user. When the user selects the charge button of the user interface of the system, a payment alert indicator is displayed to a user and the user is able to proceed with the payment process. Some actions possible from this page, include, but are not limited to, moving back to a customer list and/or creating an order.

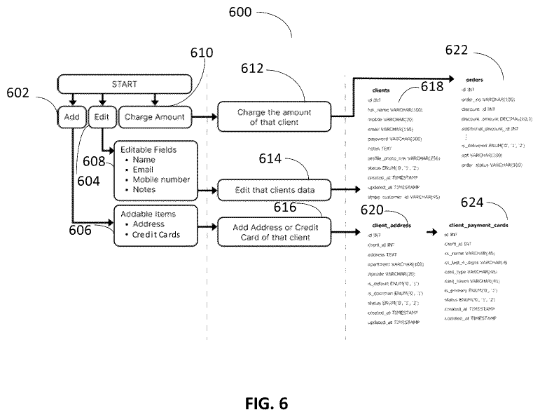

FIG. 6 depicts an illustration of a block diagram of embodiment 600 of editing 604 customer details for a system and method for dry cleaning and/or laundry logistics of FIG. 5. At 608, editable fields include, but are not limited to, name, email, mobile number, and/or notes. At 614, client data is edited. At 618, client information is created and updated with a timestamp. At 602, a user may add addable items. At 606, addable items include, but are not limited to, address and/or credit cards. At 616, the address or credit card of a client is added. At 620, client address information is created and updated with a timestamp. At 624, client payment card information is created and updated with a timestamp. At 610, charge amount is selected. At 612, the amount of a client is charged. At 622, discount amount, delivery information, and/order status is displayed.

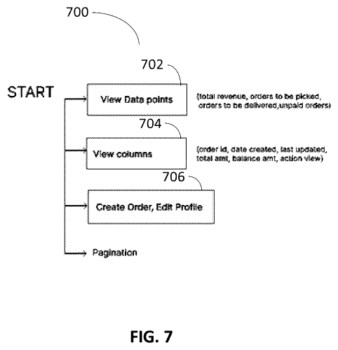

FIG. 7 depicts a flow chart illustrating embodiment 700 of order history details for a system and method for dry cleaning and/or laundry logistics. At 702, data points may be viewed such as total revenue, orders to be picked-up, orders to be delivered, and/or unpaid orders. At 704, columns may be viewed from a display of the user interface. Some of the items listed include, but are not limited to. Order identification number, date created, last update, total amount, balance amount, and/or view action button. A user may view the order details page. At 706, a user may create an order and/or edit a profile. Users may sort the data by clicking on pagination. A predetermined number of records may be displayed to a user on the first page. This page allows a user to navigate to the customer's list and or/to create an order.

In some embodiments, the system includes a machine-learning engine configured to be trained on historical laundry order datasets so that it can generate revenue projection models. The machine-learning engine operates on structured transactional records that include timestamped order information, customer identifiers, service categories, quantities or weights of items, pricing information, and/or payment status. Historical revenue values are derived directly from these records by aggregating and normalizing the order prices associated with completed transactions across predetermined time intervals such as hourly, daily, weekly, or monthly periods. The system stores these historical revenue values in association with their corresponding temporal features, enabling the construction of labeled datasets that serve as training input for the machine-learning models. Through this arrangement, the system maintains complete historical sequences of laundry order revenue, capturing seasonal variations, weekday-weekend differences, holiday effects, and/or fluctuations in customer demand.

In some embodiments, the machine-learning engine is trained using supervised learning techniques in which the model receives historical features as input and learns to predict revenue values for forward-looking periods. The historical features used in training may include raw data attributes such as order counts, item-level quantities, service type classifications, and/or transaction timestamps, as well as engineered features such as lagged revenue values, moving averages of revenue across trailing windows, rolling variance metrics, and/or retention-rate statistics. During training, the engine associates these feature vectors with ground-truth revenue outputs computed from historical point-of-sale records. The machine-learning engine may store learned model parameters, including weight matrices, bias terms, and feature-importance information, reflecting relationships between historical laundry operations and projected revenue outcomes.

In some embodiments, the training pipeline includes a data-preprocessing stage in which historical transaction data is cleaned and normalized before training begins. This may include removing duplicate transactions, correcting out-of-order timestamps, filtering anomalous pricing entries, and standardizing numerical values for consistent scaling. The system may encode categorical values such as service type and payment method using embeddings or positional encodings so that the model can properly interpret these attributes during training. By carrying out these steps, the system builds training datasets that accurately represent the operational behavior of the laundry business and support reliable model-learning behavior.

In some embodiments, the system trains the machine-learning engine using one or more predictive model architectures suited for time-series revenue forecasting. These may include gradient-boosted decision tree models configured to learn nonlinear relationships between historical revenue data and projected revenue values, and recurrent neural network models such as long short-term memory architectures configured to learn temporal dependencies in the revenue sequences. The system iteratively adjusts the model parameters through optimization processes such as gradient descent, back-propagation through time, or tree-splitting procedures designed to minimize loss functions representing the error between predicted and actual revenue values. These training procedures demonstrate possession of learned model parameters that are used to generate revenue projections based on historical laundry-business behavior.

In some embodiments, the training pipeline includes a validation stage in which the machine-learning engine evaluates the trained model using historical revenue data that was not part of the initial training set. During validation, the system may compute error values such as mean absolute error, mean squared error, or percentage-based deviation relative to known historical revenue values. Validation results may be stored and used to further refine the model parameters, ensuring alignment with real-world POS behavior and demonstrating that the system trains the model on verifiable revenue-projection outcomes.

In some embodiments, the system includes a mechanism that monitors changes in historical ordering patterns, revenue fluctuations, or customer behavior that may impact model accuracy. The system may detect drift in the underlying revenue data and retrain the machine-learning models at predetermined intervals using newly accumulated historical revenue information. Through these retraining cycles, the system maintains updated and accurate representations of historical laundry-order revenue patterns and ensures that the model's learned parameters remain aligned with current operating conditions.

In some embodiments, the trained machine-learning model is used during live inference operations to project future revenue values based on current and recently accumulated POS data. The inference engine applies the model parameters learned during the training process and uses the same categories of features used in training to generate projections for daily, weekly, or monthly revenue periods. Forecast outputs may include revenue values, confidence indicators, anomaly flags, and directional trend indicators derived from the trained model's learned variance patterns.

Across these embodiments, the written description includes the structure of the training data, the method of deriving labeled revenue outputs, the preprocessing and feature-engineering steps applied to historical revenue datasets, the model-training and model-validation procedures, and the integration of the trained model into a revenue-forecasting pipeline. These disclosures together convey that the inventor had possession of machine-learning techniques trained on historical laundry-order revenue projections at the time of filing.

In some embodiments, the system trains the machine-learning model on historical laundry-order patterns encompassing data volumes that may span several orders of magnitude. For example, small locations may produce datasets of 103 to 104 transaction records over minimal operational histories, medium locations may produce 105 to 106 records across multiple quarters, and enterprise-scale operators may generate 106 to 108 total records spanning one or more years. In some embodiments, training may occur on datasets containing 1,000 to 500,000 examples, 500,000 to 5,000,000 examples, 5,000,000 to 50,000,000 examples, or even more than 100,000,000 examples depending on storage capacity and retention policies.

The temporal span of historical patterns may range from narrow windows of 24 to 72 hours, intermediate windows of 3 to 30 days, extended windows of 30 to 365 days, or multi-year windows spanning 365 to 1,500 days. In some embodiments, the dataset may include nested time segments such as 1-day, 3-day, 7-day, 14-day, 28-day, 60-day, 90-day, 180-day, and 365-day sequences, each of which may exhibit different ordering patterns and revenue behaviors. Exponential time windows may also be used, including 2ⁿ-day windows such as 2-day, 4-day, 8-day, 16-day, 32-day, 64-day, 128-day, or 256-day patterns, allowing the model to learn behavioral patterns at exponentially increasing scales.

Historical patterns may include daily volume fluctuations ranging from ±1% to ±80% relative to a moving baseline. Within shorter intervals, hourly patterns may show 2 to 100 orders per hour at smaller sites, 50 to 500 orders per hour at medium-volume sites, and 100 to 2,000 orders per hour at large-volume sites. In some embodiments, revenue values may follow distributions where the minimum daily revenue ranges from $50 to $500, median daily revenue ranges from $300 to $15,000, and peak daily revenue may exceed $50,000 or, in large commercial operations, $100,000 or more.

Weekly revenue may range from $1,000 to $500,000, with nested ranges such as $3,000 to $10,000, $10,000 to $75,000, $75,000 to $250,000, or $250,000 to $450,000. The model may train on price distributions for individual orders ranging from $2 to $500, with nested probability masses concentrated between $7 and $45 for retail wash-and-fold orders. Laundry-weight distributions may range from 1 pound to 200 pounds per order, with subranges of 3 to 30 pounds for most residential orders and 40 to 150 pounds for commercial or institutional loads. Delivery-distance distributions may range from 0.1 to 50 miles, with sub-ranges such as 1 to 5 miles for urban customers and 5 to 20 miles for suburban customers.

In some embodiments, the training data may include hundreds of engineered features derived from the raw records. The number of features may range from 20 to 100, from 100 to 400, from 400 to 1,000, or from 1,000 to 5,000. Lagged revenue values may include lags of 1, 2, 3, 5, 7, 10, 14, 21, 30, 45, 60, 90, and 180 days. Lag windows may also be exponential, such as 2ⁿ lags, including 1-day, 2-day, 4-day, 8-day, 16-day, 32-day, 64-day, 128-day, and 256-day lags. Moving averages may be computed over windows ranging from 2 to 200 days, including intermediate ranges of 7 to 21 days, 21 to 45 days, 45 to 90 days, and 90 to 180 days. Rolling variance values may range from 0.5% to 200%, depending on volatility in customer demand.

Categorical feature patterns may include service-type distributions where wash-and-fold represents 20% to 90% of orders, dry-clean services represent 5% to 70% of orders, and commercial contracts represent 1% to 30% of orders. Pickup-and-delivery cycles may range from as few as 5 to as many as 500 pickups per day, with nested subranges including 20 to 50 pickups, 50 to 150 pickups, 150 to 300 pickups, or more than 300 pickups. Customer-retention patterns may include repeat intervals ranging from 1 to 200 days, with subranges of 2 to 14 days for high-frequency users and 30 to 90 days for occasional users. Churn thresholds may range from 20 to 180 days without an order.

Seasonal patterns may include winter declines of 10% to 50%, spring increases of 5% to 30%, summer peaks of 10% to 60%, and holiday surges of 20% to 300% depending on region and customer composition. Weather-correlated pattern ranges may include order decreases of 5% to 30% during mild weather disruptions and 20% to 60% decreases during severe events. Promotional campaigns may produce temporary increases of 10% to 250%.

Model-training hyperparameters may also span wide ranges. Gradient-boosting models may use tree depths from 2 to 40 levels, estimator counts from 20 to 10,000 trees, and learning rates from 0.0001 to 0.5. Recurrent neural networks may have between 1 and 32 layers, hidden-layer sizes from 16 to 2048 units, dropout probabilities from 0% to 90%, and training epochs from 5 to 1000. Batch sizes may range from 8 to 65,536. Optimization learning-rate schedules may include decay rates of 0.1% to 30% per epoch. Validation datasets may range from 3% to 50% of the total dataset, and validation periods may include windows of 1 to 90 days or 90 to 365 days. Forecast-horizon ranges may include near-term predictions covering 1 to 48 hours, short-term ranges of 1 to 14 days, mid-range projections of 14 to 60 days, and long-range projections of 60 to 365 days. Confidence intervals associated with predictions may range from ±1% to ±75%. Model-drift detection thresholds may vary from a 3% to a 50% degradation in prediction accuracy.

The disclosed system provides multiple technical benefits that enhance computing efficiency, data integrity, and model-inference performance in POS environments. In some embodiments, the system improves computer operation by converting irregular, latency-affected POS event logs into deterministic, temporally ordered data structures. The transaction buffer enforces timestamp monotonicity and validation constraints, which prevents data corruption arising from packet delays, jitter, and/or partial record arrivals. These ordering guarantees materially improve the reliability of subsequent preprocessing and machine-learning computations.

In some embodiments, the system offers technical benefits by implementing automated gating rules that identify predetermined portions of the transaction stream. The use of sliding windows, minimum-volume thresholds, exponential recency weighting, and seasonal-pattern validation enhances the computer's ability to select meaningful data segments. These automated selections reduce computational waste, prevent model degradation caused by noisy or unrepresentative data, and enable real-time inference at scale. Further technical benefits arise from the system's feature-engineering pipeline, which transforms raw data into vectorized, multidimensional matrices optimized for machine-learning inference. These transformations reduce memory overhead, improve cache locality, and accelerate downstream tensor operations. As a result, the system achieves lower latency, higher throughput, and improved prediction stability compared to conventional POS systems.

Additional benefits are achieved through optimized runtime containers for executing the trained model, which accelerate matrix multiplications, tensor operations, and memory access patterns. By deploying inference through ONNX- or TensorRT-compatible runtimes, the system reduces execution latency, increases frame-per-second inference rates, and supports large volumes of real-time transactions without saturating CPU resources.

The system further improves computational performance through continuous learning and drift-detection modules that automatically retrain the model when accuracy begins to degrade. These self-correcting mechanisms enhance long-term reliability and reduce the need for manual recalibration. By dynamically incorporating new historical patterns, the system maintains stable forecasting performance even as customer behaviors change. Thus, the technical benefits include improved data ordering, reduced processing latency, increased inference throughput, enhanced numerical stability, adaptive model maintenance, and robust handling of large-scale, high-velocity transactional data. These improvements allow computing devices in POS environments to perform complex forecasting computations that would not be feasible using traditional software or manual analytic methods.

In some embodiments, the system receives laundry order information as a time ordered sequence of timestamped POS records. The term “sequence” refers to a chronological progression of data entries that are stored in a transaction buffer in strictly increasing timestamp order. Each record is appended to the buffer according to its timestamp, which may have a resolution ranging from one millisecond to one second, or from one second to one minute, or from one minute to one hour depending on system configuration. The size of the sequence may range from as small as one hundred recorded transactions to as large as one hundred million recorded transactions, with intermediate ranges including one thousand to ten thousand transactions, ten thousand to one hundred thousand transactions, one hundred thousand to one million transactions, one million to ten million transactions, and ten million to twenty five million transactions.

In some embodiments, the sequence may span time intervals ranging from one hour to seventy two hours, or three days to thirty days, or twenty eight days to ninety days, or ninety days to one hundred eighty days, or six months to five years. Nested ranges may include twelve to twenty four hours, eight to fourteen days, twenty to forty days, forty five to seventy five days, or one hundred twenty to two hundred forty days. Larger operators may accumulate sequences representing two to ten years of operational history, while smaller operators may have sequences limited to one to twelve months.

In some embodiments, the system identifies a predetermined portion of the sequence by applying defined computational selection criteria. The predetermined portion is not arbitrary. Instead, it is the result of applying gating conditions that limit which subset of the sequence can be used for prediction. These gating conditions may include a sliding window requirement that selects the most recent portion of the sequence spanning four to six weeks, or three to eight weeks, or seven to twelve weeks, or fourteen to twenty four weeks. Additional gating conditions may include volume based thresholds requiring at least one thousand to one hundred thousand transactions within the window, or thresholds of two thousand to twenty thousand records, or twenty thousand to one hundred fifty thousand records, or fifty thousand to five hundred thousand records, or any quantity of records satisfying a computational stability requirement.

In some embodiments, the predetermined portion is also validated using pattern matching operations. The system may calculate seasonal similarity scores over the candidate window with required values ranging from 0.50 to 0.99, including ranges of 0.55 to 0.75, 0.75 to 0.90, or 0.85 to 0.98. The predetermined portion may also require that recency weighting satisfies an exponential decay function with decay coefficients between 0.05 and 0.95, including nested coefficients ranging from 0.10 to 0.30, or 0.20 to 0.70, or 0.60 to 0.90. The predetermined portion may also be constrained by cumulative revenue values, where the selected window must contain total revenue amounts between one thousand dollars and five million dollars, or ten thousand dollars and one million dollars, or one hundred thousand dollars and ten million dollars depending on business scale.

In some embodiments, the predetermined portion may be defined by time boundaries such as the most recent one day to seven days, or seven days to fourteen days, or fourteen days to sixty days, or sixty days to one hundred twenty days. It may also be defined by volume boundaries such as the most recent ten thousand transactions, the most recent fifty thousand transactions, the most recent two hundred thousand transactions, or any amount within a range of one thousand to ten million transactions that satisfy the selection conditions. The predetermined portion may be recomputed at time intervals ranging from every five seconds to every one hour, or every one hour to every twenty four hours.

In some embodiments, the system uses separate processing stages that distinguish preprocessing operations from execution operations. Preprocessing occurs before model invocation and includes deduplication, anomaly correction, timestamp normalization, categorical encoding, feature scaling, and computation of derived metrics. These derived metrics may include rolling averages over two to one hundred eighty days, rolling variances ranging from zero point five percent to two hundred percent, or lag values representing time offsets of one day, two days, four days, seven days, fourteen days, thirty days, sixty days, ninety days, one hundred eighty days, or two to the power of n day intervals including two days, four days, eight days, sixteen days, thirty two days, sixty four days, one hundred twenty eight days, or two hundred fifty six days.

In some embodiments, training is a separate operation performed offline or periodically using sequences that may span one month to sixty months. Training may use data volumes of ten thousand to one hundred million samples, depending on computational capacity. The training process adjusts model weights, whereas the execution process relies on fixed model weights that have already been trained.

In some embodiments, execution refers to the real time invocation of a trained model on the predetermined portion of timestamped laundry order data. Execution may occur within a specialized inference runtime environment configured for low latency performance. Execution operations may involve tensor computations, matrix multiplications, non-linear transformations, and memory optimized inference paths. Execution latency may range from one millisecond to five hundred milliseconds, with intermediate ranges of five to twenty milliseconds, twenty to one hundred milliseconds, and one hundred to three hundred milliseconds. In some embodiments, execution may involve model engines that operate within one to five hundred frames per second depending on hardware acceleration. During execution, the model processes the encoded feature data from the predetermined portion and produces outputs corresponding to forecast periods ranging from one hour to forty eight hours, or one day to seven days, or seven days to thirty days, or thirty days to ninety days, or ninety days to one hundred eighty days. These predictions may include confidence values ranging from plus or minus one percent to plus or minus seventy five percent and may include additional metrics such as anomaly scores, trend direction values, or future order volume estimates.

In some embodiments, the system implements a defined algorithmic pipeline for receiving, preparing, segmenting, and processing timestamped laundry order information. This pipeline includes an ordered sequence-construction algorithm, a predetermined-portion selection algorithm, and an inference-execution algorithm, each described herein with sufficient detail for a person skilled in the art to understand the operations performed by the computing system. These algorithmic steps are executed by computer readable instructions stored in memory and executed by one or more processors.

In some embodiments, the sequence of laundry order information is constructed using a time-ordered ingestion algorithm. As new laundry order records are received from one or more POS terminals, the system performs the operations of: (1) parsing the timestamp value for each incoming record, (2) converting the timestamp to a canonical format such as UTC epoch time expressed in seconds, milliseconds, or microseconds, (3) inserting the record into a transaction buffer according to its timestamp, and (4) performing corrective sorting operations when the timestamp of an incoming record is older than one or more existing entries. These operations guarantee a monotonic ordering of records. A PHOSITA will understand that a transaction buffer maintaining a sorted structure may be implemented using known data structures such as balanced binary trees, B-trees, skip lists, sorted arrays, or append-only logs with periodic compaction. The algorithm operates continuously as records arrive and is updated at intervals ranging from one millisecond to one minute depending on network load and POS activity.

In some embodiments, duplicate detection is performed by hashing unique order identifiers, timestamps, or combinations of features. Anomaly detection is executed by computing time deltas between sequential records. If a time delta exceeds a threshold range, such as one second to one hour, or one hour to one day, the system flags the record and applies a correction or discards the outlier. This constitutes a specific programmatic process, not a mere restatement of the claim.

In some embodiments, the predetermined portion of the sequence is identified using a multi-step computational procedure incorporating sliding window logic, numerical thresholds, and statistical validation. A PHOSITA will understand that this selection constitutes an algorithmic transformation of the sequence rather than an incidental slicing operation. For example, the system computes a window index m such that tm is the earliest timestamp that satisfies:

Tₙ minus Tₘ is within the range of twenty eight days to ninety days, or forty two days to seventy two days, or ninety days to one hundred eighty days;

AND

the number of records in the interval [tₘ, tₙ] satisfies at least one volumetric constraint such as ten thousand to fifty thousand records, or fifty thousand to one hundred thousand records, or one hundred thousand to one million records;

AND

a seasonal similarity score S between the candidate window and a historical baseline exhibits a value within the range of 0.50 to 0.99.

Seasonal similarity may be computed using a cosine similarity function:

S equals (X dot Y) divided by (norm(X) multiplied by norm(Y))

where X represents a normalized vector of historical daily or weekly demand patterns and Y represents the same metric computed on the candidate predetermined portion. The operations of vector dot products, vector normalization, and magnitude calculation constitute defined mathematical operations carried out by the processor.

The system then evaluates a recency-weighting condition using an exponential decay function:

wᵢ equals exp(−α Multiplied by dᵢ)

where dᵢ is the temporal distance between timestamp tᵢ and the most recent timestamp tₙ, and α is a decay constant in the range of 0.05 to 0.95. The predetermined portion is only accepted if the weighted density value produced by the decay function exceeds a predetermined threshold, such as a value between 0.10 and 0.90.

The predetermined portion therefore results from explicit computational rules relying on measurable sequence characteristics, algorithmic filtering, and statistical validation. The inventor possessed these procedures because the present disclosure describes the variables, computational constraints, numerical thresholds, and mathematical operations used to define the predetermined portion.

In some embodiments, the execution step differs materially from preprocessing and training. The execution algorithm is implemented by loading trained model weights from storage into an inference context configured for low latency evaluation. The system constructs a feature vector F from the predetermined portion by performing operations such as computing lag values at offsets of one day, seven days, fourteen days, thirty days, and two raised to the power of n day intervals, where n may range from one to eight. Additional operations include computing moving averages over ranges of two to one hundred eighty days and computing rolling variances within ranges of zero point five percent to two hundred percent. These feature computations are performed using vectorized numerical operations that take the form:

MAK equals (1 divided by k) multiplied by the sum of the last k revenue values

and

VARₖ equals (1 divided by k) multiplied by the sum of (Xi minus mean) squared

for k within the range of two to one hundred eighty.

In some embodiments, execution includes the forward propagation of the feature vector F through a trained model M. A gradient boosting model may compute an output by evaluating each decision tree in the ensemble, summing the leaf outputs, and applying a final scaling transformation. A recurrent neural network may compute an output by applying the standard recurrence:

hₜ equals σ(W multiplied by xₜ plus U multiplied by hₜ minus one plus b)

where W and U are weight matrices stored within the trained model, b is a bias term, h represents the hidden state, xₜ represents the input vector at time t, and σ represents a nonlinear activation function. These matrices may contain between one hundred and one million individual weight values. A PHOSITA would understand that executing these matrix multiplications and activation functions constitutes a specific algorithmic operation carried out by the processor.

The execution algorithm then produces numerical outputs representing predicted revenue values for future periods such as one hour, twelve hours, twenty four hours, seven days, or thirty days. Confidence values are calculated by propagating error variance from the trained model using statistical operations such as variance decomposition, covariance propagation, or bootstrap sampling of subsets of the predetermined portion. These operations constitute explicit algorithmic procedures familiar to a PHOSITA.

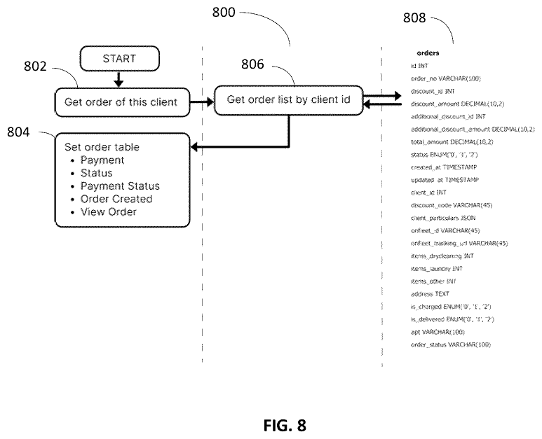

FIG. 8 depicts an illustration of a block diagram of embodiment 800 of order history details for a system and method for dry cleaning and/or laundry logistics of FIG. 7. At 802, the client order is taken. At 806, an order list is generated by the client identification number. At 804, the order table is set with information including, but not limited to, payment, status, payment status, order creation, and or viewing order. At 808, order information is displayed.

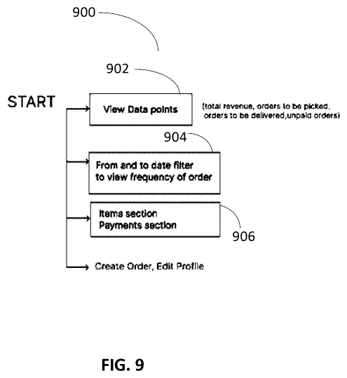

FIG. 9 depicts a flow chart illustrating analytics page 900 for a system and method for dry cleaning and/or laundry logistics. At 902, data points are viewed including, but not limited to total amount, total orders, average price, canceled orders, and/or amount to be paid. A graph is displayed to a user with order rate and income. At 904, frequency order is viewable with a from and to date filter. Data may be filtered by selecting a date range. The total number of dry cleaning items, wash and clean items, and/or alterations may be displayed to a user through user interface. At, 906, an items section and a payments section is viewable through a user interface of a display of an electronic device. The API to show data points includes, but is not limited to, signup order date, first order date, and/or latest order date. A graph for order frequency may show order information. For example, the number of orders per month. An items section pie chart may show the percentage for all the items which are tailored and/or washed with the application system application for the customer. Some of the actions possible from this page include, but are not limited to, navigation back to the customer's list, and/or create order.

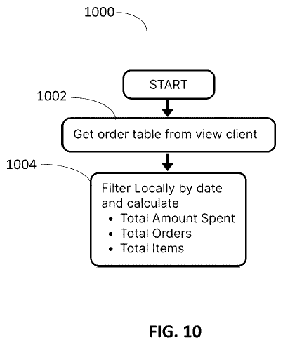

FIG. 10 depicts a flow chart illustrating analytics for a system and method for dry cleaning and/or laundry logistics, according to embodiment 1000. At 1002, an order table is received from view client. At 1004, filtering locally by date and calculating total amount spent, total orders, and/or total items.

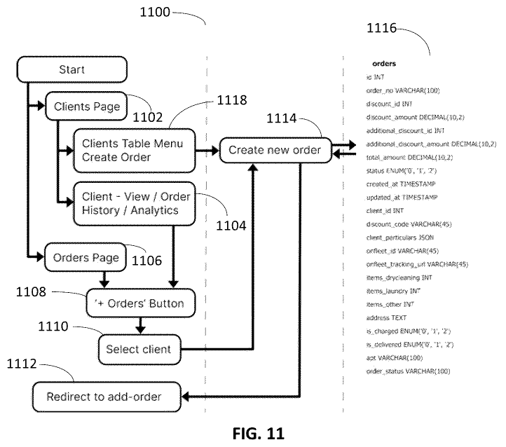

FIG. 11 depicts an illustration of a block diagram of embodiment 1100 of adding an order for a system and method for dry cleaning and/or laundry logistics of FIG. 9. At 1102, the client's page is displayed. At 1118, the client's table menu is displayed. At 1114, a user may create a new order. At 1116, the tables used to form the add-orders page are illustrated. At 1112, redirecting to add-order. At 1110, selecting a client. At, 1104, the possible actions from this page include a client viewing, order history, and/or analytics. Order intake may be enabled when for example, a garment is delivered to the store including, but not limited to, adding items, adding tags, adding notes, adding images, adding a discount, and/or charging and delivery options. At 1106, the orders page allows a user access to the add orders button at 1108. At 1110, the client is selected.

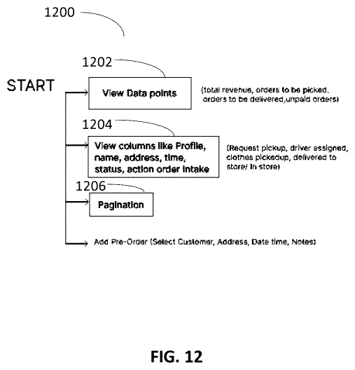

FIG. 12 depicts a flow chart illustrating a pre-orders dashboard 1200. At 1202, view data points include, but are not limited to, total revenue, orders to be picked, orders to be delivered, and/or unpaid orders. At 1204, view columns including, but not limited to, profile, name, address, time, status, action order intake. This page allows a user to request a pick-up, shows the driver assigned, clothes picked up and/or delivered to the store and/or in store. At 1206, pagination allows a user to sort the data by clicking on pagination. A pre-order may be added. The customer is selected along with the address, date, time, and/or notes. This module shows two types of requests. The first request is when the software application, for example, receives a request from the customer to pick up dirty clothes for drycleaning. The second request occurs when, for example, the customer drops off dirty clothes at the store.

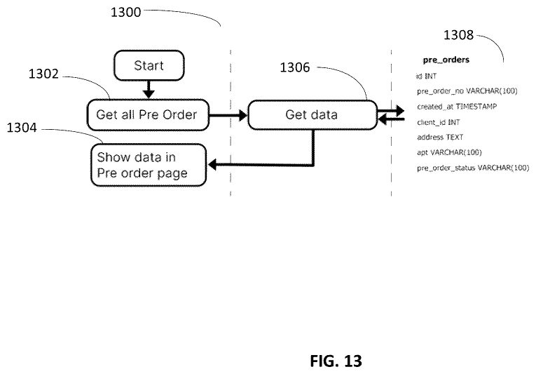

FIG. 13 depicts an illustration of a block diagram of an embodiment of pre-order dashboard 1300 for a system and method for dry cleaning and/or laundry logistics of FIG. 12. At 1302, the list of pre-orders has columns with data for profile information, name, address, time, and status. At 1304, the detailed flow of on-fleet is displayed to a user such as data for requesting a pick-up, the driver assigned, the garments to be picked-up, and/or store delivery information. At 1306, a user may retrieve data. At 1308, pre-order data is timestamped. It is within the scope of this invention for a pre-order to be added. The fields displayed on the user interface of the application include, but are not limited to, selecting customer, selecting an address, date, time, and/or notes. The actions possible from this page include, but are not limited to, order intake enabled when a garment is delivered at the store directly by the customer. A customer may download pre-orders. For example, a customer may download a report in excel format.

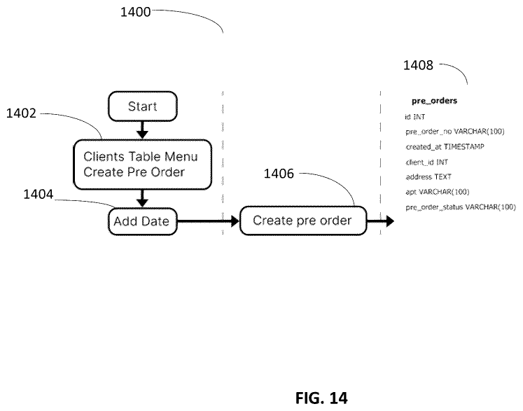

FIG. 14 depicts an illustration of a block diagram of an embodiment of dashboard 1400 for adding a pre-order for a system and method for dry cleaning and/or laundry logistics of FIG. 12. At 1402, a client may access a table menu to create a pre-order. At 1404, a date is added. At 1406, a pre-order is created. At 1408, pre-order's that are created are timestamped.

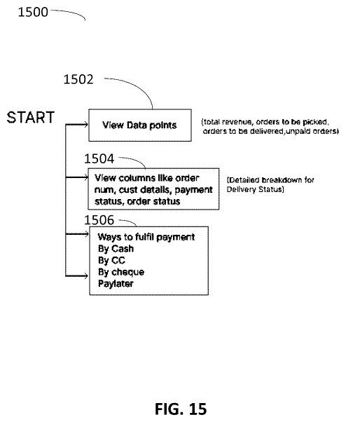

FIG. 15 depicts a flow chart illustrating orders dashboard 1500 and adding a pre-order for a system and method for dry cleaning and/or laundry logistics. At 1502, data points viewed include, but are not limited to, total revenue, orders to be picked, orders to be delivered, and/or unpaid orders. At 1504, a detailed itemization of the delivery status is displayed. The user accesses, through the user interface of the application, to view columns of data including, but not limited to, order number, customer details, payment status, and/or order status. At 1506, payment may be fulfilled by cash, credit card, check, and/or pay later. The list of orders have states being completed, pre-order, draft, unpaid, delivery failed, alteration, client pick-up, and/or delivery failed. When the state of the order is completed, an example of an action taken is no action is required. Under the action column, the information about the name of the payment method is displayed to a customer, through the user interface of the display. If the credit card used for payment is a credit card, then the credit card number and the transaction date will be displayed through the display of the user interface. The delivery status column will display the state of the delivery based on the on fleet response There are two states shown, ready for delivery and delivery completed. An action is possible by a user clicking on a view order icon, The user will be redirected to an order details page. A charge action icon may be selected by a user to charge a customer using a different payment method. In an example, if the make order icon is selected by a user, the user will be taken to an order intake module for an order selected.

When the payment alert box opens and is displayed to a user, a credit card dropdown menu for credit card payments is displayed. The payment alert box fields include, but are not limited to, select payment method, select the credit card listed in the system, amount, and/or notes. The actions possible on this alert box include, charge and complete when the customer is present, charge and start delivery when a delivery is to be done using on fleet, and/or charge and ready for pick-up when the customer has requested a later pick-up.

When the payment alert box is displayed on the user interface, the cash dropdown menu is displayed. The fields on the payment alert box are to select the payment method, the email address pre-filled for the customer, a mobile number, and/or the amount due. When the user selects the charge icon, the cash module is updated.

When the payment alert box opens, there is a pay later dropdown selection. The fields on the payment alert box include, but are not limited to, select payment method, email address pre-filled for the customer, mobile number, and/or add credit amount. When the user selects the add credit icon, the amount will be added for the user in the view section.

When the payment alert box opens, a check selection dropdown is displayed. The fields on the payment alert box include, but are not limited to, select payment method, check number, amount, upload images. When the user selects the add and/or save icon, the amount will be deducted offline when the check is deposited.

When the state of the order is pre-order, the action taken may include a charge action. A charge action icon may be selected by a user to charge a customer using a different payment method. In an example, if the make order icon is selected by a user, the user will be taken to an order intake module for an order selected. The delivery columns have not data in this state.

When the state of an order is a draft, the action that may be taken includes, selecting a view order icon by a user to be directed to an order details page. An action and a delivery column have no data in this state.

When the state of an order is unpaid, an action in the action column of the user interface includes a charge action button. If selected by a user, the customer will be charged using a different payment method. In this state, the delivery columns have no data. In an example of a possible action in this state, a user may select the view order icon to direct a user to be taken to an order details page for their order.

During the alteration state of an order, the actions column may have a contact tailor icon. This button may be configured to remind the user with an alert and/or a message to contact the tailor offline and/or to contact the tailor directly. Another state is tailor's job complete and pay the tailor. The tailor payment icon will be displayed to a customer with a payment alert message displayed to a customer on the user interface of the application. Another action that may be taken during the alteration state of an order is the selection of a view order icon. A user may be taken to an order details page for a specific order. In this state of order, the delivery column will have no data. The three states available for this column is request tailor pick-up, tailoring, and delivered to store. The data received from on fleet will allow the state to be updated.

When the state of the order is delivery failed, the action that may be taken includes, but is not limited to, an on fleet task and/or a contact client action. When a user selects the on fleet task icon, a request is sent to the on fleet and a task is created again for delivery. When a user selects the contact client icon, the user will be redirected to the client details module. This state of order will have no delivery data. The column has two states. The first message will be displayed to a user to show the three states with delivery failed state. The second message will be displayed to a user to illustrate the state of the new delivery. Data in these message boxes will be filled based on the on fleet responses, When the view order icon is selected by a user, the user will be directed to the order details page for their desired order.

When the state of the order is client pick-up, the action elements include client pick-up and contact client. During client pick-up, once the client has picked up the cleaned garment from the store, the user can select this icon to change the state of the order to complete. During contact client, this icon will redirect the user to the client details module. In this state the delivery column has no data. When the view order is selected by a user, a user will be directed to the order details page for the specific order. When the state of the order is pay later, the action may include a user selecting the action element, invoice sent and paid. When the user clicks on this button, the state can be updated to completed and an invoice will be sent to the customer on the registered email address on file. In this state the delivery column has no data. This column has the state of ready for delivery and delivery completed. When the view order is selected by a user, a user will be directed to the order details page for the specific order.

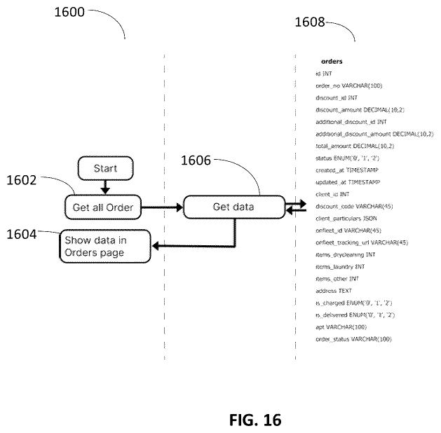

FIG. 16 depicts an illustration of a block diagram of embodiment 1600 of a module for stages of an order for a system and method for dry cleaning and/or laundry logistics of FIG. 15. At 1602, the order is retrieved. At 1606, the order data is obtained. At 1604, the data is displayed on the orders page. At 1608, the order is created and timestamped.

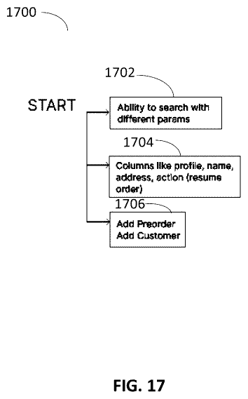

FIG. 17 depicts a flow chart illustrating a draft order dashboard 1700 for a system and method for dry cleaning and/or laundry logistics. At 1702, the user has an ability to search with different parameters. At 1704, columns shown have a list of data for profile, name, and/or address information associated with a draft order. Pagination may be added. Filter functionality is a feature of this embodiment. It is within the scope of this invention for a user to click on resume order and go back to the order details module and complete the order. Further, a user may navigate back to the customers list and/or the orders list. At 1706, a preorder and/or a customer may be added.

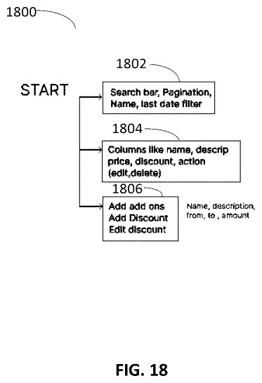

FIG. 18 depicts a flow chart illustrating discounts dashboard 1800 for a system and method for dry cleaning and/or laundry logistics. At 1802, the search bar, pagination, name, and last date filter are some examples of columns shown. At 1804, columns include, name, description of price, discount, and/or action such as edit and/or delete. At 1806, in the master module, users may define all discounts add an add-on, and/or add a discount. When showing the list of add-ons, a user may navigate to the customers list and/or the orders list. The add-ons may be added and/or edited. The fields shown include, but are not limited to, name, description, from date, to date, and/or amount of cost or percentage. A user may add a new add-on and/or edit the add-on.

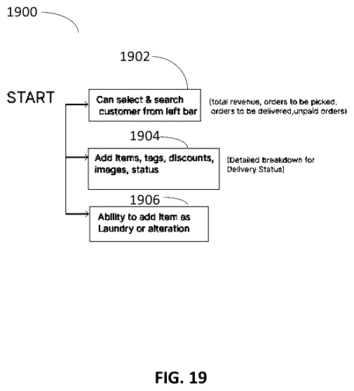

FIG. 19 depicts a flow chart illustrating adding orders in order intake dashboard 1900 for a system and method for dry cleaning and/or laundry logistics. At 1902, the selection and search options for a customer occur in the left bar such as the total revenue, orders to be picked-up, orders to be delivered, and/or unpaid orders. At 1904, items, tags, discounts, images, and status may be added. At 1906, an item may be added such as laundry and/or an alteration item.

When the user desires to add an order into the system, the order intake process begins with adding an item. When the user selects the add item icon, a pop-up is displayed. The user selects a price, quantity, discount amount or percentage, and/or a discount. A user may add add-ons to an item selected. For example, the color and the property of the add-on for blue, price, and/or discount price for each add-on.

A user may view the list of items added in the receipt displayed on at least a portion of the display. When adding a tag, an order identification field generates an identifier displayed on the display. The tag identifier may be manually entered or automatically displayed. The tag identifier is associated with a dropdown menu that a user may select an item. The dropdown menu may be prefilled with the items added in the cart by a user. The user may add tags. Discounts may be added in a list displayed to a user. It is within the scope of this invention for a user to add images of dirty clothes and add notes.

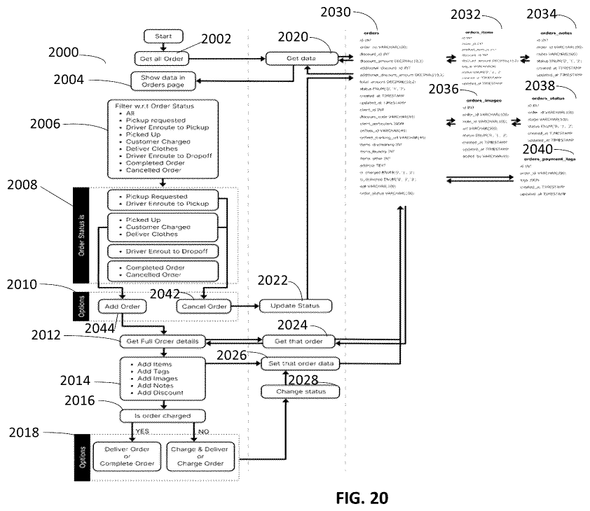

FIG. 20 depicts an illustration of a block diagram of an embodiment of adding orders in order intake dashboard 2000 for a system and method for dry cleaning and/or laundry logistics of FIG. 19. At 2002, the order is retrieved. At 2020, the data is received. At 2004, the data is displayed in the orders page. At 2006, the order status is filtered by all, pick-up requested, driver enroute to pick-up, customer charged, deliver clothes, driver enroute to drop-off, completed order, and/or canceled order. At 2008, if the order statis is a pick-up requested and/or driver is enroute to pick-up, the order may be canceled at 2042 and the status is updated at 2022. If the order status is picked up, customer charged, and/or deliver clothes at 2044, an order may be added. At 2012, full order details are generated and displayed. At 2023, the order is retrieved. At 2014, added items, tags, images, notes, and/or discounts may be added. At 2026, order data is set. At 2016, if order is charged, then at 2018 the order may be delivered and/or the order may be completed. At 2016, if order is not charged, then at 2018 the order may be charged and delivered and/or the order may be charged. At 2010, options are to add order 2044 and/or cancel order 2042. At 2028, the order status may be updated. At 2030, the order is created and updated with a timestamp. At 2032, order items are created and updated with a timestamp. At 2034, order notes are created and updated with a timestamp. At 2036, order images are created and updated with a timestamp. At 2038, order status is created and updated with a timestamp. Users may visualize on the display the state of the order. States with date timestamps include, but are not limited to, pick-up requested, driver assigned, picked up delivered to store, order intake, customer charged, deliver clothes, and/or order complete. At 2040, order payment logs are created and updated with a timestamp. At 2024, the order is retrieved.

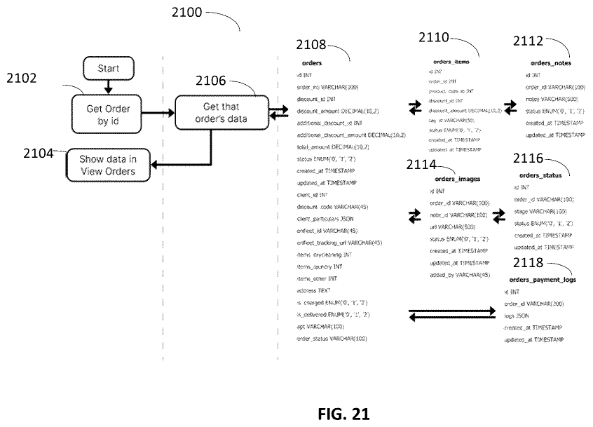

FIG. 21 depicts an illustration of a block diagram of an embodiment of order details module 2100 for a system and method for dry cleaning and/or laundry logistics. At 2102, the order is generated by an associated identifier. At 2106 the data of an order is retrieved. At 2104, the data is displayed in view orders. At 2108, the orders data is created and updated with a timestamp. At 2110, order items are created and updated with a timestamp. At 2112, the orders notes are created and updated with a timestamp. At 2114, the orders images are created and updated with a timestamp. At 2116, the orders status is created and updated with a timestamp. At 2118, the orders payment logs are created and updated with a timestamp. When a user selects on view order from the orders page, a user will be redirected to the order details page. The fields on the order details page include, but are not limited to, receipt with the items, subtotal, price, tags associated with assigned items and a list of tags, states with date timestamps, and/or image notes.

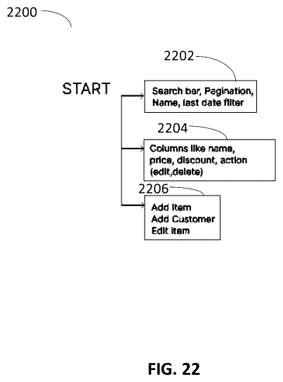

FIG. 22 depicts a flow chart illustrating items master module 2200 for a system and method for dry cleaning and/or laundry logistics. At 2202, search bar, pagination, name, and last date filter are shown. At 2204, a list of items such as name, price, discount are shown. At 2206, a user may edit, add, and/or delete an item. A customer may be added.

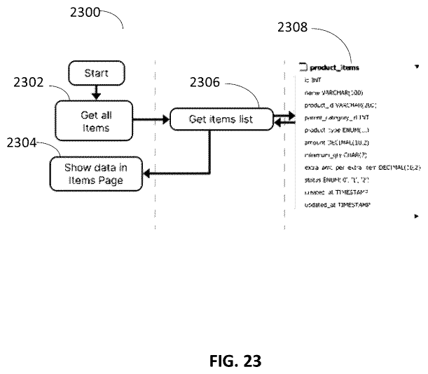

FIG. 23 depicts an illustration of a block diagram of an embodiment of items module 2300 for a system and method for dry cleaning and/or laundry logistics of FIG. 22. At 2302, all items are retrieved. At 2306, the item list is retrieved. At 2304, the data is displayed in the items page. At 2308, product items are created and updated with a timestamp.

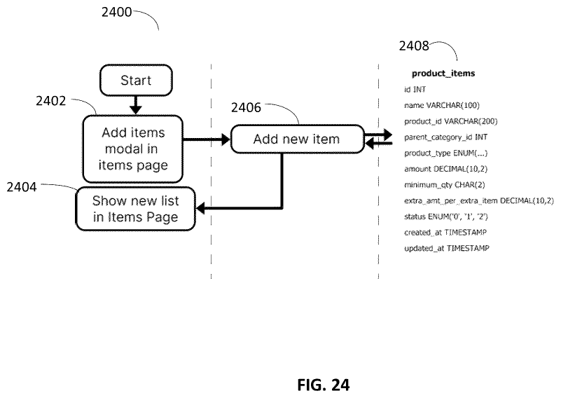

FIG. 24 depicts an illustration of a block diagram of an embodiment of items module 2400 having the ability to add an item for a system and method for dry cleaning and/or laundry logistics. At 2402, items are added in the items page. At 2406, a new item is added. At 2404, the new list is displayed in the items page. The fields shown are name, price, and/or discount. At 2408, the product items are created and updated with a timestamp.

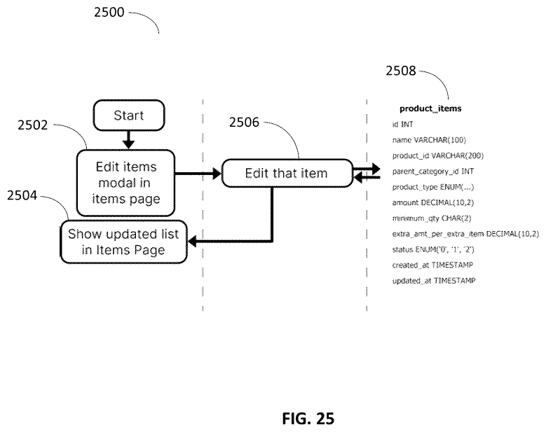

FIG. 25 depicts an illustration of a block diagram of an embodiment of items module 2500 having the ability to edit an item for a system and method for dry cleaning and/or laundry logistics. At 2502, items may be edited in the items page. At 2506, an item is edited. At 2504, the updated list is displayed in the items page. At 2508, product items are created and updated with a timestamp.

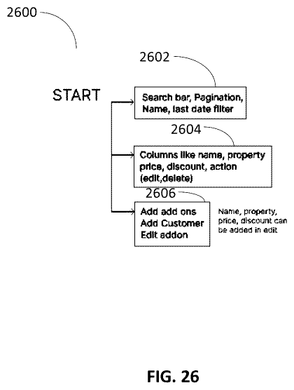

FIG. 26 depicts a flow chart illustrating add-ons master module 2600 for a system and method for dry cleaning and/or laundry logistics. At 2602, the search bar, pagination may be added, filter functionality is available, name, and/or last date may have a column listed. At 2604, columns listed include, name, property price, discount and/or an action. At 2606, a user may define the add-on data. The user may edit the item, delete the item, navigate to a customer's list, add a customer, and/or navigate to an orders list.

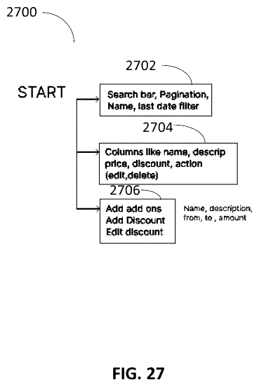

FIG. 27 depicts a flow chart illustrating discounts dashboard 2700 for a system and method for dry cleaning and/or laundry logistics in which a user may define all the discounts. At 2702, the search bar, pagination may be added, filter functionality is available, name, and/or last date may have a column listed. At 2704, columns shown include, but are not limited to name, description, amount, discount, action, and date of availability. At 2706, a user may define the discount data. The user may edit the item, delete the item, navigate to a customer's list, add a customer, and/or navigate to an orders list.

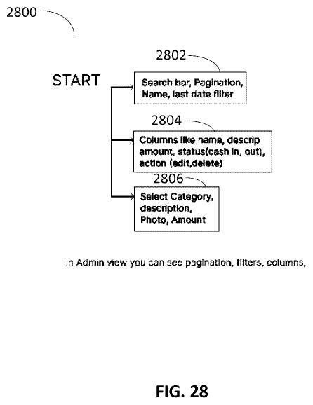

FIG. 28 depicts a flow chart illustrating cash flow module 2800 for a system and method for dry cleaning and/or laundry logistics. This module maintains cash flow throughout the day. In an example, each employee adds cash in and cash out entries when cash is added and/or removed from the store. Cash left and calculated cash left amount at the end of a day should be equal. If not, then a notification will be sent to the administrator regarding the discrepancy. At 2802, the search bar, pagination may be added, filter functionality is available, name, and/or last date may have a column listed.

At 2804, columns shown include, but are not limited to name, description, status of cash in, status of cash out, and/or action. At 2806, selecting category, description, photo and/or amount may be available to a user.

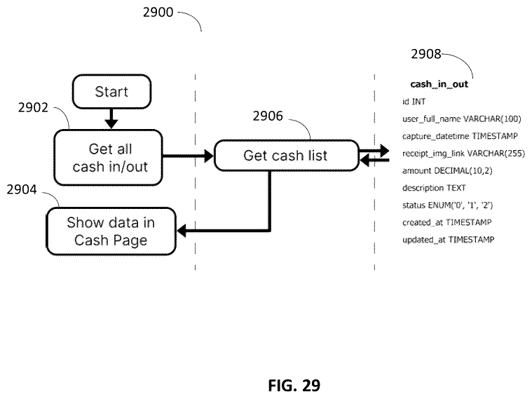

FIG. 29 depicts a flow chart illustrating an embodiment of for cash flow module 2900 for a system and method for dry cleaning and/or laundry logistics. At 2902, all cash in and all cash out is received. At 2906, a cash list is generated. At 2904, data is displayed in the cash page. At 2908, cash in and/or out is created and updated with a timestamp.

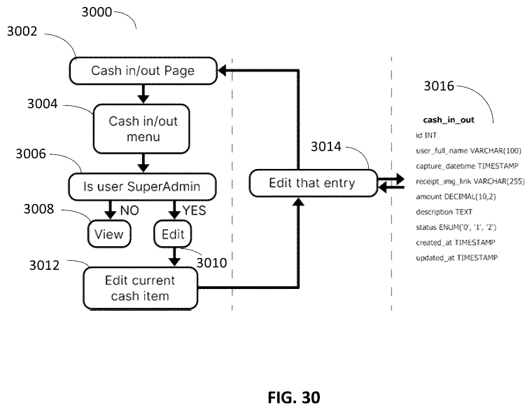

FIG. 30 depicts a flow chart illustrating cash register module 3000 configured to edit a cash entry for a system and method for dry cleaning and/or laundry logistics. In this embodiment, the ability for a user to add and edit a cash entry is shown. At 3002, a cash in/out page is displayed. At 3004, a cash in/out menu is generated and displayed. At 3006, if the administrator is an authorized user, at 3010, they may be determined by the system to have authorization to edit data. If the administrator is not an authorized user, at 3008, they may be determined by the system to have not be authorization to edit data and to only view data. At 3012, the authorized administrator may edit a current cash item. At 3014, an entry is edited. At 3016, cash in and/or out is created and updated with a timestamp.

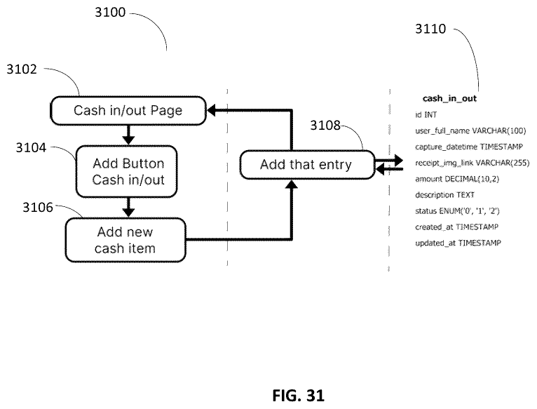

FIG. 31 depicts a flow chart illustrating an embodiment of cash register module 3100 configured to add a cash entry for a system and method for dry cleaning and/or laundry logistics. At 3102, the cash in/out page shows a list of cash flow entries. The list will display only cash in and cash out entries done by all the users. There are four cards shown on the main screen with data points including, but not limited to, total revenue, starting cash, current cash, ending cash, and/or a date and day. At 3104, add button is selected for cash in/out. At 3106, a new cash item is added. At 3108, an entry is added. At 3110, cash in and/or out is created and updated with a timestamp.

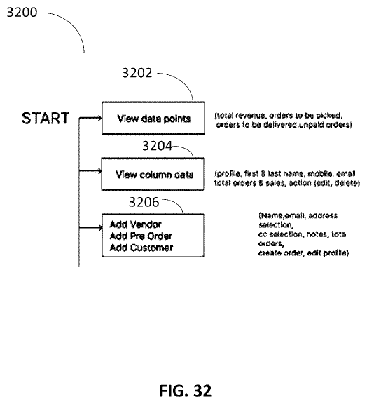

FIG. 32 depicts a flow chart illustrating a module showing vendor listing 3200 for a system and method for dry cleaning and/or laundry logistics. This module shows the list of all vendors associated with an alteration service, for example. At 3202, the data point listed are displayed such as total revenue from alteration, alteration orders in progress, alteration orders completed, and/or total amount paid to the tailors. At 3204, the column data is shown including, but not limited to, profile data, first name, last name, mobile, email address, total orders, total sales, and/or last order. At 3206, details of a vendor, a pre-order, and/or a customer may be added.

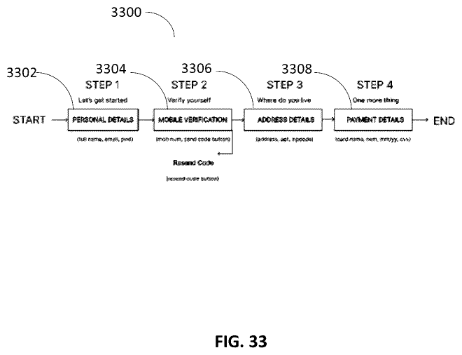

FIG. 33 depicts a flow chart illustrating third party sign-up module 3300 for a system and method for dry cleaning and/or laundry logistics. At 3302, adding personal details includes, but is not limited to, full name, email address, and/or a password. At 3304, mobile verification occurs and the data collected is a mobile number and a resend code button is provided. At 3306, address details are collected including, but not limited to, address, apartment number, and/or zip code. At 3308, payment details are collected including, but not limited to, card name, card number, expiration data, and/or security code.

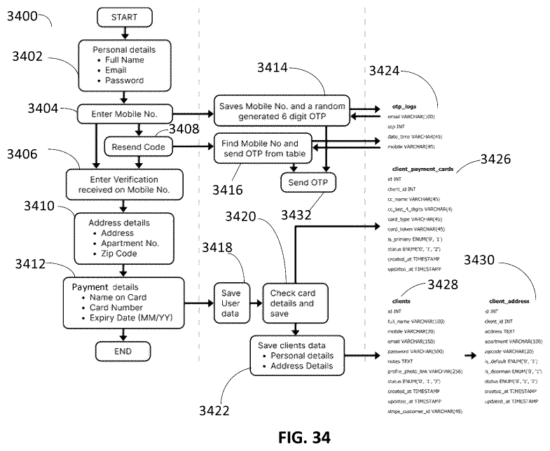

FIG. 34 depicts an illustration of a block diagram of an embodiment for third party sign-up module 3400 for a system and method for dry cleaning and/or laundry logistics of FIG. 33. At 3402, personal details such as full name, email, and password are collected. At 3404, entering a mobile number is performed by a user. At 3414, the mobile number is saved and a random six digit identifier such as a one-time password (OTP) is generated. At 3424, OTP logs are available. At 3408, the code is resent. At 3416, the mobile number is found and an OTP is sent from the table. At 3432, an OTP is sent. At 3406, a verification code sent to the mobile number is entered by a user. At 3406, the verification number is received by an electronic device associated with a mobile number, The verification number is entered. At 3410, Address details are collected. At 3412, payment details are collected. At 3418, user data is saved. At 3420, card payment details are checked for accuracy and saved. At 3422, client data is saved such as, personal details and address details. At 3426, client payment card data creates and updates a timestamp. At 3428, client data creates and updates a timestamp. At 3430, client address data creates and updates a timestamp.

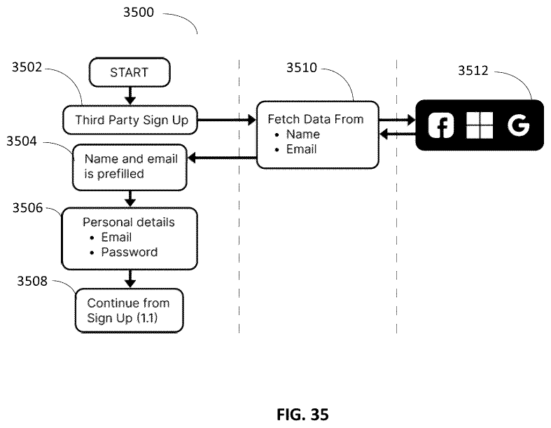

FIG. 35 depicts an illustration of a block diagram of an embodiment for third party sign-up module 3500 for a system and method for dry cleaning and/or laundry logistics. At 3502, a third party sigh up page is displayed. At 3510, data such as name and email is retrieved. At 3504, name and email is prefilled in the webform field. At 3506, personal details such as email and password are input by a user into the webform. At 3508, continuing from sign-up occurs. At 3512, a third party includes, but is not limited to, Facebook, email, and/or Microsoft.

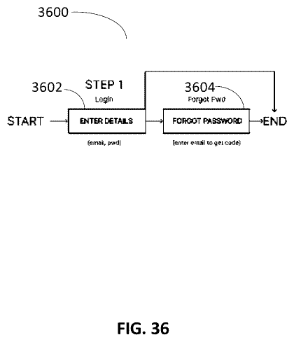

FIG. 36 depicts a flow chart illustrating third party login module 3600 for a system and method for dry cleaning and/or laundry logistics. At 3602, login details are entered such as email address and/or a password. At step, 3604, if the password is forgotten, the email address may be input to output a new code. The new code is sent to the email address in file. A new password may be reset and confirmed.

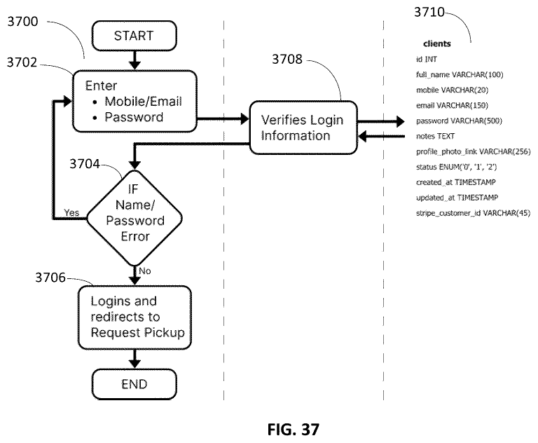

FIG. 37 depicts an illustration of a block diagram of an embodiment for third party sign-login module 3700 for a system and method for dry cleaning and/or laundry logistics of FIG. 36. At 3702, a mobile number and/or password is entered into the interface. At 3708, login information is verified. At 3710, client data is created and updated with a timestamp. At 3704, if the name and/or password is in error, the user is prompted to enter the mobile number and/or password again. If the name and/or password is not in error, at 3706, logins and redirects client to request pick-up.

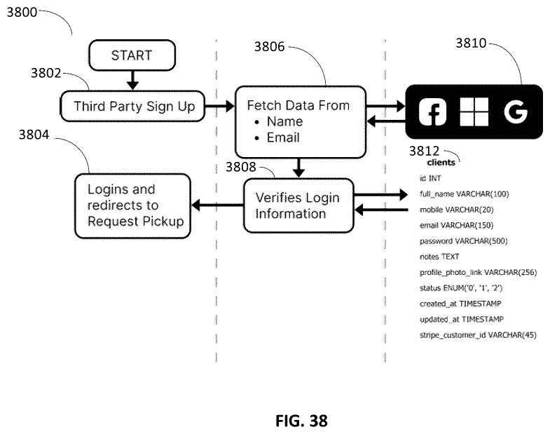

FIG. 38 depicts an illustration of a block diagram of forget password module 3800 for a system and method for dry cleaning and/or laundry logistics. At 3802, a user signs up using a third party. At 3806, data id retrieved from a name and email provided by a user. At 3808, login credentials are verified. At 3804, logins and redirects to request pick-up. At 3810, a user may sign in using a third party including, but not limited to, Facebook, Gmail, and/or Microsoft login credentials. At 3812, client data is created and updated with a timestamp.

In some embodiments, the computer program includes executable instructions that, when rendered by a graphical user interface engine of a computing device, generate a dashboard and a set of interactive components for receiving, processing, and analyzing timestamped laundry order information. As records are received from one or more POS terminals, the computer converts each timestamp into a normalized temporal format such as epoch milliseconds, epoch seconds, or ISO formatted time values, which may represent resolutions ranging from one millisecond to one hour, or one second to ten seconds, or ten seconds to five minutes. The system inserts each record into a transaction buffer that maintains a sequence of laundry order information arranged in strictly increasing temporal order. The buffer may contain as few as one hundred records, or between one thousand and ten thousand records, or between ten thousand and one hundred thousand records, or between one hundred thousand and five million records, or more than fifty million records for enterprise scale deployments. In some embodiments, the buffer spans a time interval ranging from one hour to seventy two hours, or three days to thirty days, or twenty eight days to ninety days, or ninety days to one hundred eighty days, or six months to three years, or three years to ten years of operational history. Out of sequence records may be corrected or re inserted using sorting operations or reorder queues. The sequence therefore constitutes a structured, machine generated time ordered dataset rather than an incidental list of timestamps.

In some embodiments, the computer program applies a selection procedure to identify a predetermined portion of the sequence that is suitable for machine learning inference. The predetermined portion is determined using sliding temporal windows such as the most recent seven days to fourteen days, or fourteen days to sixty days, or twenty one days to ninety days, or one month to four months. Additional selection conditions may require that the portion contains a minimum volume of data such as at least one thousand transactions, or five thousand to fifty thousand transactions, or fifty thousand to two hundred thousand transactions, or two hundred thousand to one million transactions. Seasonal or periodic patterns may be evaluated by computing similarity scores, which may include cosine similarity, correlation coefficients, or normalized dot products. These similarity values may be required to fall within ranges from 0.50 to 0.99, or 0.55 to 0.85, or 0.70 to 0.95. Recency weighting factors may be computed using exponential decay values with decay parameters ranging from 0.05 to 0.95, or 0.10 to 0.40, or 0.40 to 0.80. In some embodiments, the predetermined portion is reevaluated at intervals ranging from every five seconds to every sixty seconds, or every one minute to every fifteen minutes, or every fifteen minutes to every twenty four hours, depending on system load and POS activity. These algorithmic steps demonstrate a concrete computational mechanism for determining which subset of the full sequence is used during the machine learning execution phase.

In some embodiments, the computer program transforms the predetermined portion into a set of numerical and categorical features by performing operations such as normalization, one hot encoding, rolling calculations, and lag computations. Lag values may be calculated at offsets of one day, two days, three days, five days, seven days, fourteen days, thirty days, forty five days, sixty days, or ninety days, or using exponential intervals such as two days, four days, eight days, sixteen days, thirty two days, sixty four days, one hundred twenty eight days, or two hundred fifty six days. Rolling averages may be computed across ranges of two to seven days, or seven to twenty one days, or twenty one to sixty days, or sixty to one hundred eighty days. Rolling variance values may be computed across windows with ranges from zero point five percent to two hundred percent. Derived metrics may include order count per hour, order count per day, revenue per order, revenue per hour, revenue per day, or any combination of temporal aggregates. Price values may range from two dollars to five hundred dollars per order, or five dollars to fifty dollars per order for most wash and fold services. Order weights may range from two pounds to thirty pounds for household orders, or thirty pounds to two hundred pounds for commercial orders.

In some embodiments, execution refers to the computer program loading trained machine learning model weights into an inference environment. The trained model may be a gradient boosted tree model with between twenty and five thousand estimators, or between two and forty decision depth levels, or learning rates between 0.0001 and 0.5. Alternatively, the trained model may be a neural network with between one and thirty two layers, with hidden unit sizes ranging from sixteen to two thousand forty eight units, with dropout values ranging from zero percent to ninety percent, trained over epochs ranging from five to one thousand. Inference may involve matrix multiplications and activation functions executed within time intervals ranging from one millisecond to five hundred milliseconds, or five milliseconds to fifty milliseconds, or fifty milliseconds to one hundred fifty milliseconds. Predictions generated during execution may include future revenue values for intervals ranging from one hour to twenty four hours, or one day to seven days, or seven days to thirty days, or thirty days to one hundred eighty days.

In some embodiments, the computer program provides the third party sign up module using the same graphical user interface engine that renders the dashboard. The module is a software based registration interface generated as an interactive screen, panel, or modal window containing input fields, event listeners, submission routines, and network communication handlers. When the user selects an onboarding option within the dashboard, the computer program loads the module definition from memory, instantiates the registration interface, generates input fields for full name, email address, password, address details, payment card information, and mobile number, and renders the interface within the display. The module is therefore “provided” by generating the user facing interface in real time and making it interactable. The module collects user details by capturing keystrokes, validating entries, and storing information in a client account record. Mobile verification is performed using a onetime password algorithm that generates numeric codes such as three digit to nine digit numeric values, or values ranging from one hundred to one hundred thousand, or one hundred thousand to nine hundred ninety nine thousand. The OTP is stored in an OTP log that includes timestamp metadata, validity intervals ranging from thirty seconds to thirty minutes, and retry counters. Submission of the user entered OTP triggers a comparison routine that validates the entered value and updates the client account timestamp using formats such as epoch seconds, epoch milliseconds, or ISO formatted strings.

In some embodiments, timestamp updates occur whenever a user submits new credentials, verifies a mobile number, or modifies address or payment card information. The timestamp values may represent times ranging from one millisecond resolution to one second resolution, or time offsets measured in seconds, minutes, or hours. Client data may be stored in secure storage systems including relational tables, key value stores, encrypted JSON structures, or distributed ledger entries. Across these embodiments, the details of the algorithms, procedures, data structures, computational ranges, user interface rendering operations, and OTP verification logic demonstrate that the inventor possessed the full scope of the claimed subject matter, including the third party sign up module and the manner in which it is provided, executed, and integrated with the larger laundry order processing and machine learning forecasting system.

In some embodiments, the computer program maintains an OTP log within a defined memory or storage subsystem associated with the computing device executing the program or with a server side storage system that communicates with the computing device. The OTP log may be stored in volatile memory such as RAM, in nonvolatile memory such as flash storage, or in a persistent database table hosted on a remote server, and may take the form of a key value store, a relational table, an append only event register, or an encrypted data record. The location of the OTP log is therefore not external or undefined. Instead, it is a machine readable data structure created and updated by the instructions executed by the computing device. The OTP log may occupy as little as a few bytes for a single record or may grow to tens of kilobytes or megabytes depending on the number of verification events, with entries ranging from one to hundreds of thousands of OTP verification attempts over time. In some embodiments, the OTP log is allocated in a specific namespace or container within the memory of the computing device or the server application, such as a “verification store,” “authentication ledger,” or “user onboarding record set,” all of which represent structured computer controlled repositories.

In some embodiments, each entry in the OTP log contains the generated OTP value, a timestamp representing the time of generation, an expiration interval such as thirty seconds to thirty minutes, a retry count ranging from zero to ten attempts, and optionally metadata identifying the user session, device identifier, or IP address associated with the request. The OTP log may store these values as numerical fields, encoded strings, hash values, or encrypted tokens depending on security requirements. The use of a defined storage location ensures that each OTP can be programmatically validated by comparing the user entered value against the stored entry before the expiration time. When the user enters the OTP into the graphical user interface, the third party sign up module retrieves the corresponding OTP entry from the OTP log by executing a lookup function that searches by user identifier, mobile number, session identifier, or OTP token. The retrieved timestamp is compared to a current system clock value stored within the computing device or server memory to confirm that the OTP remains valid. These operations are performed entirely within the processor address space or managed memory of the computing system and therefore the OTP log is structurally and operationally part of the claimed system rather than an abstract concept or an undefined external resource.

In some embodiments, storage of the OTP log may use memory regions ranging from one kilobyte to one gigabyte depending on the number of users and verification frequency. For small deployments, the OTP log may contain between ten and one hundred entries stored in a lightweight on device memory cache. For medium sized systems, the OTP log may contain between one thousand and one hundred thousand entries stored in a secure database table. For large multiregional deployments, the OTP log may contain between one million and fifty million entries distributed across several storage nodes. The OTP log may be written using atomic update operations to ensure consistency, and may implement expiration routines that periodically remove entries older than expiration intervals such as one minute to one hour, or one hour to twenty four hours. These programmed memory management routines demonstrate that the OTP log exists as a concrete data structure maintained through deterministic computing operations rather than an incidental reference.

In some embodiments, the OTP log may be synchronized across multiple devices or servers if the registration interface is accessed through a multi node or cloud based architecture. Synchronization intervals may range from real time to five seconds, or five seconds to sixty seconds, or one minute to fifteen minutes depending on system configuration. The OTP entries are transmitted over secure channels such as TLS encrypted API calls or internal service to service communication protocols. A PHOSITA would recognize that storing the OTP log in such memory controlled environments ensures that the log is maintained within the computing ecosystem executing the third party sign up module and is therefore an accessible and integral part of the program.

In some embodiments, the OTP log is stored in a secured database table such as “otp_log,” “verification_codes,” or “client_auth_codes,” and includes indexed fields for efficient lookup. The index may involve the mobile number, the OTP token, the user identifier, or the timestamp. Retrieval operations may involve scanning, hashing, or query execution depending on the database model. These structural components demonstrate that the system implements a concrete and machine controlled storage element for OTP values.

In some embodiments, the OTP log is tied to the broader client data repository that stores personal details, address information, payment card data, and onboarding timestamps. When the OTP verification succeeds, the computer program updates a client account record within the same memory or storage hierarchy that contains the OTP log. Updated records may include timestamps ranging from millisecond resolution to one second or one minute resolution. These updates ensure data consistency across the registration subsystem.

In some embodiments, the computer program receives laundry order information that includes one or more timestamps. These timestamps may represent logistical events such as order creation, order pickup, order processing, or order delivery, and may also represent analytical timestamps that indicate when the record was stored in memory. The timestamps may be expressed with resolutions ranging from about 0.001 seconds to about 3 seconds, or from about 3 seconds to about 300 seconds, or from about 300 seconds to about 3,600 seconds. Using these timestamps, the computer program generates a sequence of laundry order information arranged in chronological order, the sequence comprising timestamped laundry order data. The number of entries in the sequence may range from about 100 to about 1,000 entries, or from about 1,000 to about 10,000 entries, or from about 10,000 to about 100,000 entries, or from about 100,000 to about 1,000,000 entries, or from about 1,000,000 to about 100,000,000 entries depending on deployment size. The corresponding time span represented in the sequence may range from about 1 hour to about 72 hours, or from about 72 hours to about 720 hours, or from about 30 days to about 180 days, or from about 180 days to about 1,825 days.

In some embodiments, the predetermined portion of the timestamped laundry order data is defined as a machine selected subset of the sequence that satisfies one or more programmed selection criteria. The predetermined portion may cover a time window ranging from about 7 days to about 14 days, or from about 14 days to about 30 days, or from about 30 days to about 60 days, or from about 60 days to about 90 days, or from about 90 days to about 180 days. The predetermined portion may also require a minimum number of timestamped records ranging from about 100 to about 500 records, or from about 500 to about 5,000 records, or from about 5,000 to about 50,000 records, or from about 50,000 to about 200,000 records, or from about 200,000 to about 1,000,000 records. In some embodiments, the computer program computes a similarity score that must fall within a range from about 0.50 to about 0.99, or from about 0.60 to about 0.95, or from about 0.75 to about 0.90 to ensure that the selected portion reflects stable historical patterns. Recency weighting values may be generated using an exponential decay function having coefficients ranging from about 0.05 to about 0.95, or from about 0.10 to about 0.40, or from about 0.40 to about 0.80. The predetermined portion is therefore a defined subset extracted from the sequence based on explicit computational conditions applied to timestamped laundry order data.

In some embodiments, after the predetermined portion is identified, the computer program constructs feature vectors using the timestamped laundry order data within the portion. Lag features may be calculated at offsets ranging from about 1 day to about 3 days, or from about 3 days to about 7 days, or from about 7 days to about 14 days, or from about 14 days to about 30 days, or from about 30 days to about 90 days. Exponential lag intervals may be computed for offsets ranging from about 2 days to about 4 days, or from about 4 days to about 8 days, or from about 8 days to about 16 days, or from about 16 days to about 32 days, or from about 32 days to about 128 days. Moving average values may be computed for windows ranging from about 2 days to about 7 days, or from about 7 days to about 21 days, or from about 21 days to about 60 days, or from about 60 days to about 180 days. Rolling variance values may be computed within ranges from about 0.5 percent to about 50 percent, or from about 10 percent to about 100 percent, or from about 20 percent to about 200 percent depending on business variability. In some embodiments, executing the computer program on the predetermined portion refers to performing a model inference operation using the trained machine learning model. Execution involves applying the trained model weights to the feature vectors derived from the predetermined portion. When the model is a tree based model, execution may involve evaluating from about 20 to about 5,000 decision trees. When the model is a neural network, execution may involve computing from about 1 to about 32 layers, each containing from about 16 to about 2,048 parameters.

Execution times may range from about 1 millisecond to about 50 milliseconds, or from about 50 milliseconds to about 150 milliseconds, or from about 150 milliseconds to about 500 milliseconds depending on computational hardware. The predicted values generated during execution may include revenue projections or order frequencies for future windows ranging from about 1 hour to about 24 hours, or from about 24 hours to about 7 days, or from about 7 days to about 30 days, or from about 30 days to about 90 days.

In some embodiments, the timestamp used to create the sequence and to identify the predetermined portion is the same timestamped laundry order data used during execution. Although a logistics timestamp for operational events and an analytical timestamp for processing may both exist within the system, both values originate from the same underlying temporal record and are normalized before the sequence is generated. The computer program uses the same timestamped laundry order data during the full sequence of operations including generating the sequence, selecting the predetermined portion, constructing features, and performing execution. This ensures temporal consistency throughout the computational pipeline.

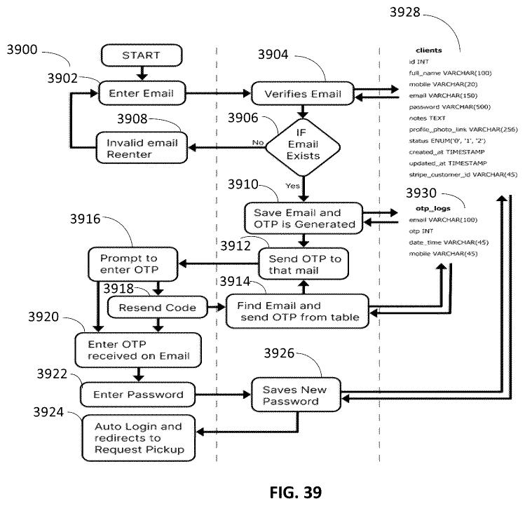

FIG. 39 depicts an illustration of a block diagram of an embodiment for forget password module 3900 for a system and method for dry cleaning and/or laundry logistics. At 3902, an email address is entered. At 3904, the email address is verified. At 3928, client data is created and updated with a timestamp. At 3906, the system determines if an email address exists. At 3908, if the email does not exist, the email address is invalid and a user is prompted to reenter the email address. At 3910, if the email address exists, the email address is saved and an OTP is generated. At 3930, OTP logs are available. At 3912, an OTP password is sent to the associated email address. At 3916, a user is prompted to enter the OTP. At 3918, the OTP code is resent. At 3914, the email address is found and the OTP is sent from the table. At 3920, the OTP received by the email address is entered into the system. At 3922, a password is entered by a user. At 3924, auto login occurs and redirects a user to request a pick-up. At 3926, the new password is saved.

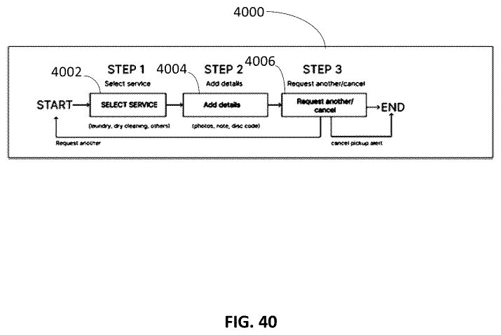

FIG. 40 depicts a flow chart illustrating request pickup module 4000 for a system and method for dry cleaning and/or laundry logistics. At 4002, a service is selected from the options including, but not limited to, laundry, dry cleaning, shoes, alterations, leather, and/or suede. An address from where a pick-up location is submitted through the webform. At 4004, details are added including, but not limited to, photos, a note, and/or a discount code. At 4006, a subsequent pick-up may be requested. Alternatively, an alert may be generated to confirm is a pick-up has been canceled.

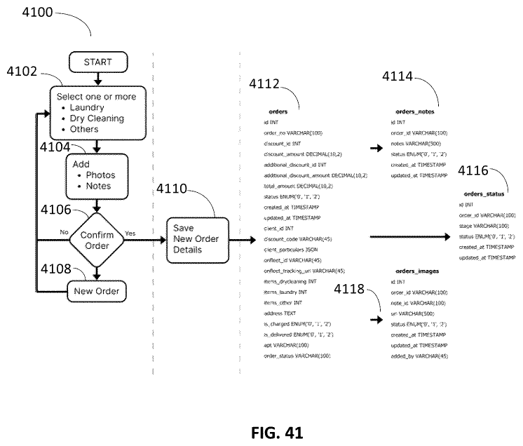

FIG. 41 depicts an illustration of a block diagram of an embodiment for request pickup module 4100 for a system and method for dry cleaning and/or laundry logistics. At 4102, a service is selected from the options including, but not limited to, laundry, dry cleaning, shoes, alterations, leather, and/or suede. At 4102, details are added including, but not limited to, photos, a note, and/or a discount code. At 4104, photos and/or notes may be added. At 4106, the order is confirmed. At 4110, new order details are saved. At 4108, a new order is generated. At 4112, order details are created and generated with a timestamp. At 4114, order notes are created and generated with a timestamp. At 4116, order status details are created and generated with a timestamp. At 4118, order image details are created and generated with a timestamp.

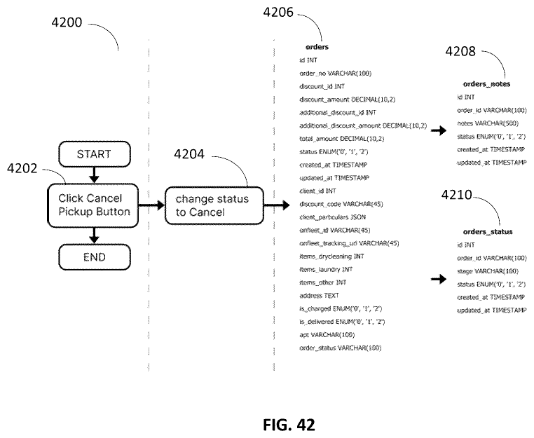

FIG. 42 depicts an illustration of a block diagram of an embodiment for cancel pickup module 4200 for a system and method for dry cleaning and/or laundry logistics. Canceling an order after a predetermined time may result in a cost incurred as a penalty and/or a violation. At 4202, a user may select a cancel pick-up icon in the user interface of the display having the application. At 4204, the status is changed to cancel. At 4206, order details are created and generated with a timestamp. At 4208, order note details are created and generated with a timestamp. At 4210, order status details are created and generated with a timestamp.

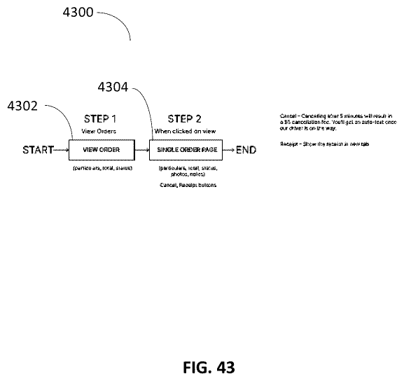

FIG. 43 depicts a flow chart illustrating a view orders module 4300 for a system and method for dry cleaning and/or laundry logistics. At 4302, the list of orders is viewable including, but not limited to, order details, photos, notes, total amount, status, and/or receipt data. At 4302, the order is viewable. At 4304, when the view button is selected, the total amount, status, a photo, a note, a detail of the order, and/or a cancellation button is available for a user to select.

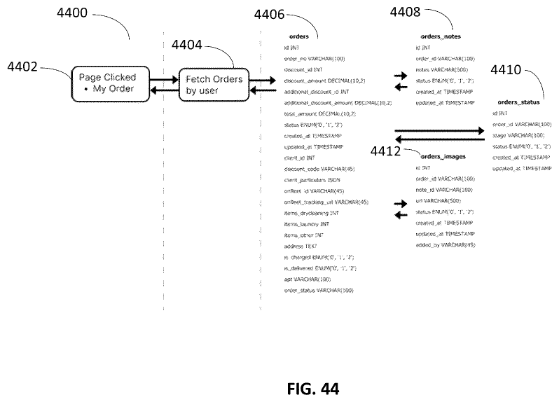

FIG. 44 depicts an illustration of a block diagram of an embodiment for view orders module 4400 for a system and method for dry cleaning and/or laundry logistics of FIG. 43. At 4402, when my order page is selected, a user clicks on the icon within the user interface of a display. At 4404, the user navigates to collect order data. At 4406, order details are created and generated with a timestamp. At 4408, order note details are created and generated with a timestamp. At 4410, order status details are created and generated with a timestamp. At 4412, order image details are created and generated with a timestamp.

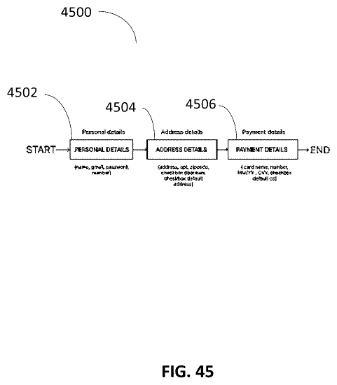

FIG. 45 depicts a flow chart illustrating profile module 4500 for a system and method for dry cleaning and/or laundry logistics. At 4502, personal details such as name, email address, password, mobile number, and/or profile photo are added to a profile. At 4504, a user inputs into the webform, address information, apartment information, and/or zip code. At 4506, payment details are input by a user into webform.

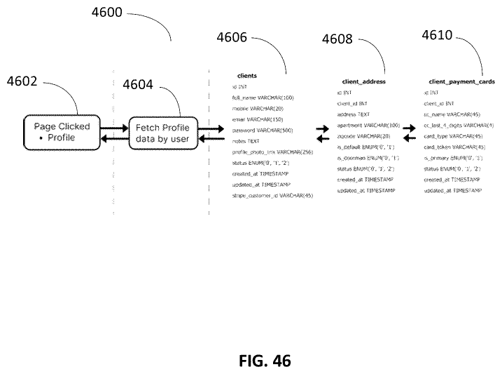

FIG. 46 depicts an illustration of a block diagram of an embodiment for profile module 4600 for a system and method for dry cleaning and/or laundry logistics of FIG. 45. At 4602, the profile page is selected by a user when a user clicks on the page. At 4604, the user retrieves the profile data. At 4606, client details are created and generated with a timestamp. At 4608, client address details are created and generated with a timestamp. At 4610, client payment card details are created and generated with a timestamp.

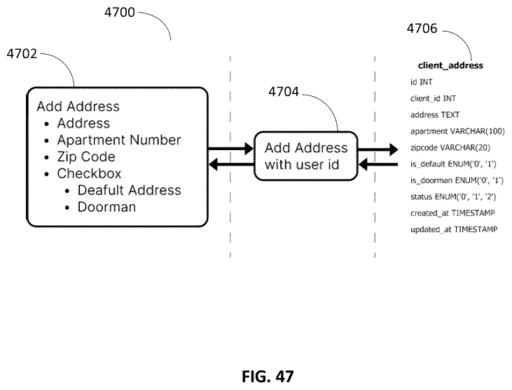

FIG. 47 depicts an illustration of a block diagram of an embodiment for adding address details to profile module 4700 for a system and method for dry cleaning and/or laundry logistics. At 4702, Address information is added. At 4704, an address is added with a user identifier. At 4706, client address details are created and generated with a timestamp.

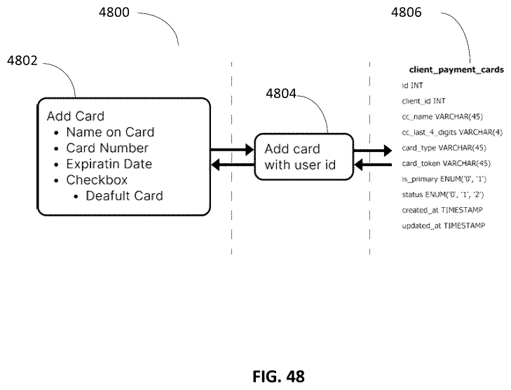

FIG. 48 depicts an illustration of a block diagram of an embodiment for adding card payment details to profile module 4800 for a system and method for dry cleaning and/or laundry logistics. At 4802, payment information is added. For example, card payment information is added. At 4804, card payment information is added with a user identifier. At 4806, client card payment details are created and generated with a timestamp.

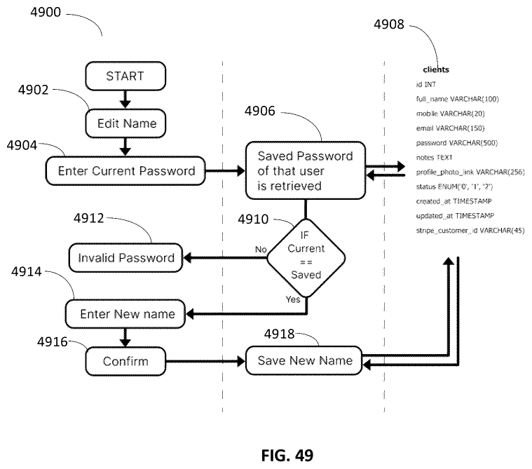

FIG. 49 depicts an illustration of a block diagram of an embodiment for editing personal details in profile module 4900 for a system and method for dry cleaning and/or laundry logistics. At 4902, a name is edited. At 4904, the current password is entered into the user interface. At 4906, the saved password of the associated user is retrieved. At 4908, client details are created and generated with a timestamp. At 4910, if the system detects that the currently entered password does not match a retrieved saved password, then the password is invalid at 4912. If the system detects that the currently entered password does match a retrieved saved password, then the password is valid and at 4914, a new name is entered in the webform by a user. At 4916, the user confirms the input data. At 4918, the new name is saved.

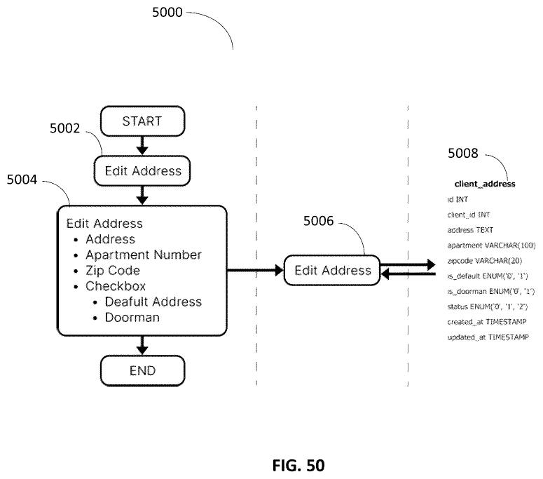

FIG. 50 depicts an illustration of a block diagram of an embodiment for editing address details in profile module 5000 for a system and method for dry cleaning and/or laundry logistics. At 5002, an address is edited. At 5004, editable address information includes, but is not limited to, address, apartment number, zip code, default address, and/or doorman information. At 5006, the address is edited and updated. At 5008, client address details are created and generated with a timestamp.

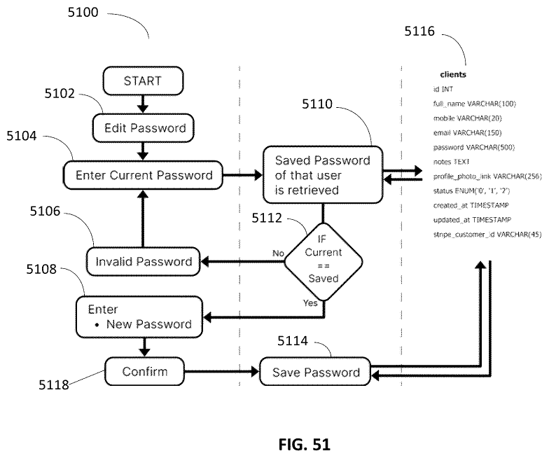

FIG. 51 depicts an illustration of a block diagram of an embodiment for editing password details in profile module 5100 for a system and method for dry cleaning and/or laundry logistics. At 5102, the password may be editable. At 5104, the current password is entered. At 5110, the saved password of the user is retrieved. At 5116, client details are created and generated with a timestamp. At 5112, if the system detects that the currently entered password does not match a retrieved saved password, then the password is invalid at 5106. If the system detects that the currently entered password does match a retrieved saved password, then the password is valid and at 5108, a new password is entered in the webform by a user. At 5118, the user confirms the input data. At 5114, the new password is saved.

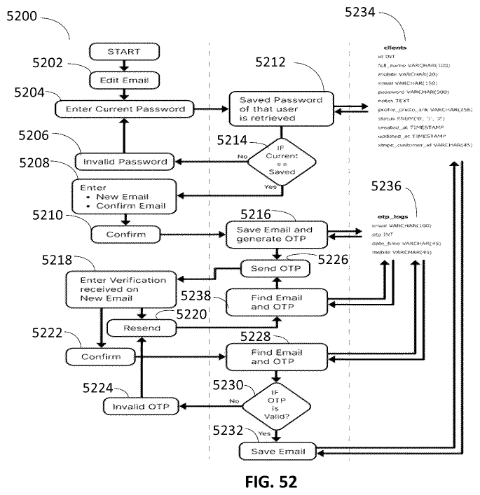

FIG. 52 depicts an illustration of a block diagram of an embodiment for editing email details in profile module 5200 for a system and method for dry cleaning and/or laundry logistics. At 5202, an email address is edited. At 5204, current password is entered. At 5212 the saved password of the user is retrieved. At 5234, client data is created and updated with a timestamp. At 5214, if the system detects that the currently entered password does not match a retrieved saved password, then the password is invalid at 5206. If the system detects that the currently entered password does match a retrieved saved password, then the password is valid and at 5208, a new email address is entered in the webform by a user. At 5210, the user confirms the input data. At 5216, the new email address is saved and an OTP is generated. At 5236, OTP log data is retained. At 5226, an OTP password is sent to the associated email address. At 5218, a user is prompted to enter the verification OTP received by the new email address. At 5220, the OTP code is resent. At 5238, the email address is found and the OTP is sent from the table. At 5222 the verification OTP is confirmed. At 5228, the email address is retrieved and the corresponding OTP. At 5230, the system determines if the OTP is valid. At 5224, the OTP is invalid. At 5232, the OTP is valid and the email address is saved.

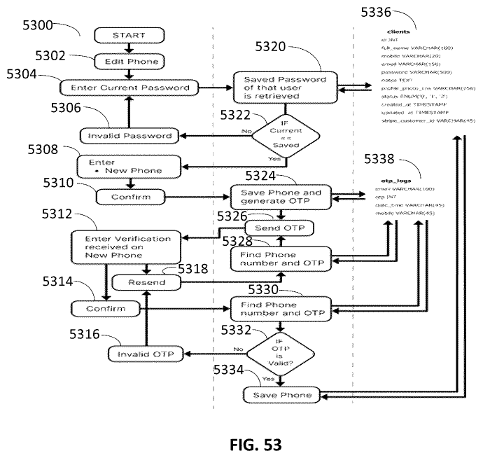

FIG. 53 depicts an illustration of a block diagram of an embodiment for editing mobile number details to profile module 5300 for a system and method for dry cleaning and/or laundry logistics. At 5302, a phone number is edited. At 5304, the current password is entered. At 5320 the saved password of the user is retrieved. At 5308, a new phone number is entered into the graphical user interface. At 5336, client data is created and updated with a timestamp. At 5322, if the system detects that the currently entered password does not match a retrieved saved password, then the password is invalid at 5306. If the system detects that the currently entered password does match a retrieved saved password, then the password is valid and at 5306, a new phone number is entered in the webform by a user. At 5310, the user confirms the input data. At 5324, the new phone number is saved and an OTP is generated. At 5338, OTP log data is retained. At 5326, an OTP password is sent to the associated phone number. At 5312, a user is prompted to enter the verification OTP received by the new email address. At 5318, the OTP code is resent. At 5328, the phone number is found and the OTP is sent from the table. At 5314 the verification OTP is confirmed. At 5328, the phone number is retrieved and the corresponding OTP. At 5330, the phone number is found by the system and an OTP is generated. At 5332, the system determines if the OTP is valid. At 5316, the OTP is invalid. At 5334, the OTP is valid and the email address is saved.

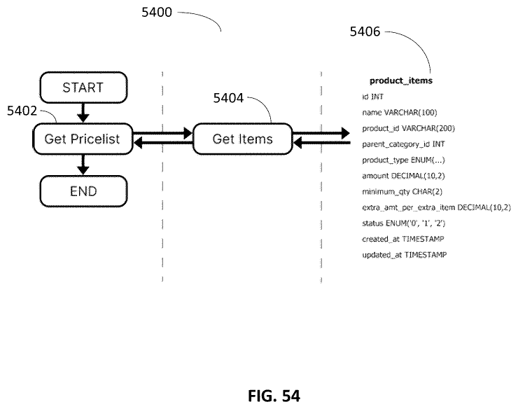

FIG. 54 depicts an illustration of a block diagram of an embodiment accessing price list data 5400 for a system and method for dry cleaning and/or laundry logistics. At 5402, a pricelist is retrieved. At 5404, items are retrieved. At 5406, product item data is created and updated with a timestamp.

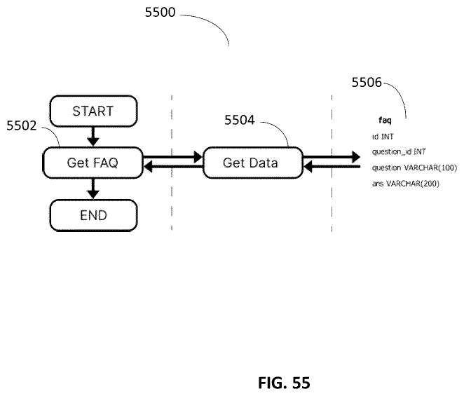

FIG. 55 depicts an illustration of a block diagram of an embodiment accessing informative data 5500 for a system and method for dry cleaning and/or laundry logistics. At 5502 read-only data is retrieved. At 5504, data such as question and answers, facts, information about a company, and/or information about products and/or services provided by a company is accessible to a user through a display accessing the application. At 5506, the data is retained and viewable.

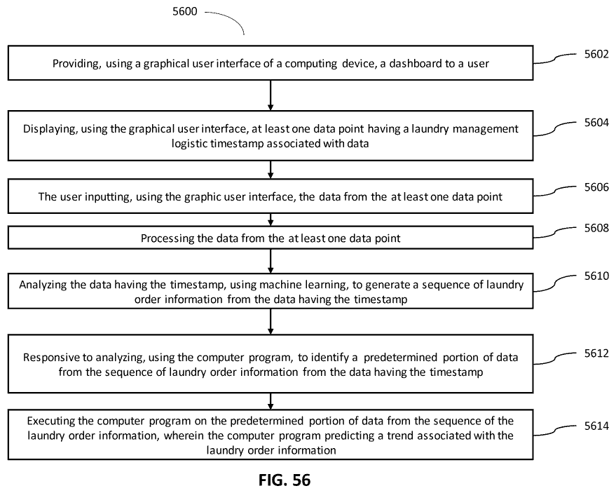

FIG. 56 depicts a flow chart illustrating method 5600 for dry cleaning and/or laundry logistic generation. At 5602, providing, using a graphical user interface of a computing device, a dashboard to a user. At 5604, displaying, using the graphical user interface, at least one data point having a laundry management logistic timestamp associated with data. At 5606, the user inputting, using the graphic user interface, the data from the at least one data point. At 5608, processing the data from the at least one data point. At 5610, analyzing the data having the timestamp, using machine learning, to generate a sequence of laundry order information from the data having the timestamp. At 5612, responsive to analyzing, using the computer program, to identify a predetermined portion of data from the sequence of laundry order information from the data having the timestamp. At 5614, executing the computer program on the predetermined portion of data from the sequence of the laundry order information, wherein the computer program predicting a trend associated with the laundry order information.

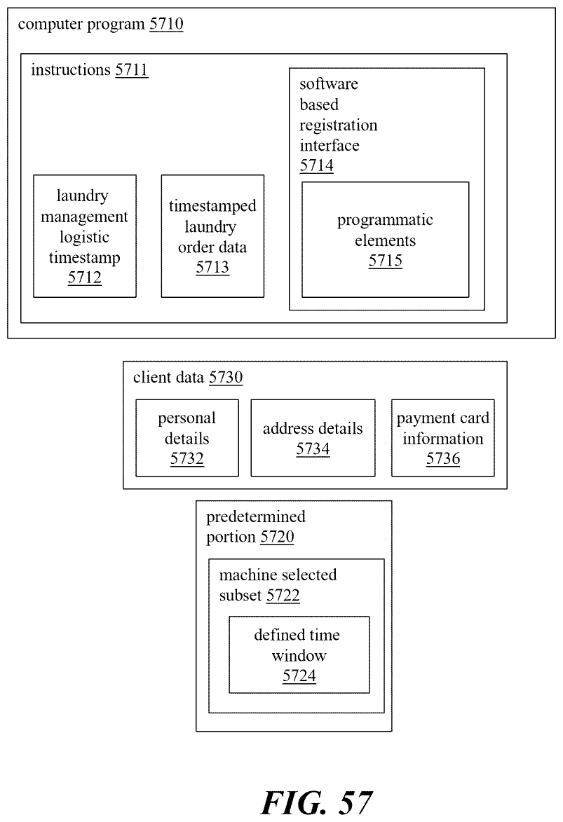

FIG. 57 illustrates an example arrangement of components used to implement the computer program 5710. In some embodiments, the computer program 5710 includes instructions 5711 stored in a computer readable memory and executable by one or more processors of a computing device. The instructions 5711 may include operations for obtaining a laundry management logistic timestamp 5712 associated with an order processed through a laundry management system. The laundry management logistic timestamp 5712 may indicate order creation time, pickup time, in-store handling time, or delivery time and may be formatted as epoch time, UNIX time, or ISO-formatted timestamp strings. The instructions 5711 further obtain timestamped laundry order data 5713 derived from records of historical and real-time laundry transactions. The timestamped laundry order data 5713 may include information for any number of data points ranging from a single record to tens of millions of records, depending on the scale of the system.

The computer program 5710 causes the computing device to render, through a graphical user interface, a dashboard enabling a user to review operational metrics. The dashboard may display data points containing the laundry management logistic timestamp 5712 and visual indicators showing the status of each order. A user may input values into the dashboard or modify displayed data through interactive controls, and such user input is collected and stored by the computing device. As the data is entered, the instructions 5711 process the data to ensure proper formatting, relational consistency, and temporal ordering.

The instructions 5711 analyze the timestamped laundry order data 5713 using one or more trained machine learning models. In some embodiments, the computer program organizes the timestamped records into a sequence that preserves chronological order, and this sequence may span minutes, hours, days, or weeks of activity. The system may generate the sequence using sorting, duplicate-removal procedures, and timestamp normalization. Once arranged in the sequence, the timestamped data is used to derive additional features such as order frequency, order category, and revenue indicators, which are passed through the machine learning algorithms to identify trends.

The instructions 5711 further identify, from the sequence, a predetermined portion 5720 of the timestamped laundry order data. As illustrated, the predetermined portion 5720 may include a machine selected subset 5722 that satisfies selection conditions encoded within the instructions. These conditions may require that the subset be drawn from a defined time window 5724 such as the most recent days or weeks of timestamped laundry order data, and that the subset contains at least a minimum number of records to ensure statistical reliability. The system may compute similarity scores, recency weighting coefficients, and validation metrics to determine whether the selected portion meets the conditions required for model execution. After the predetermined portion 5720 is selected, the instructions 5711 execute a model inference operation using the trained machine learning model.

Execution may involve transforming values in the predetermined portion 5720 into numerical feature vectors, loading trained parameters into memory, and applying those parameters to the feature vectors to compute predicted trends. These predicted trends may include projected order frequency, expected revenue amounts, or anticipated changes in demand for a particular time interval. During execution, the computer may apply forward-propagation operations, matrix operations, or decision-tree evaluations depending on the structure of the trained model.

In some embodiments, the instructions 5711 also include a software based registration interface 5714 provided to a user through the graphical user interface. The registration interface 5714 includes programmatic elements 5715 configured to collect user information during a third-party sign-up process. The programmatic elements 5715 include interactive fields for receiving personal details such as a full name, an email address, and a password. Input from these fields is stored in the client data 5730, which may include personal details 5732, address details 5734, and payment card information 5736. The system may encrypt, tokenize, or otherwise secure the stored client data.

During registration, the instructions 5711 cause the computing device to receive a mobile number provided by the user. The computer program generates a one-time password and stores the one-time password in an OTP log that may be maintained within memory of the computing device or within a server based storage system. The computer program transmits the one-time password to the provided mobile number and, if requested by the user, resends the one-time password. Each verification attempt may be recorded in the OTP log to preserve a time-stamped record of registration activity.

As registration information is submitted, the system creates and updates timestamps associated with the client data 5730. These timestamps may indicate when the personal details 5732, address details 5734, or payment card information 5736 were first entered or last modified. The timestamped client data is stored in the client account record and used during future authentication or account management operations. The arrangement illustrated in FIG. 57 shows one example implementation of the computer program 5710, the instructions 5711, and associated data structures used to carry out the operations of the system.

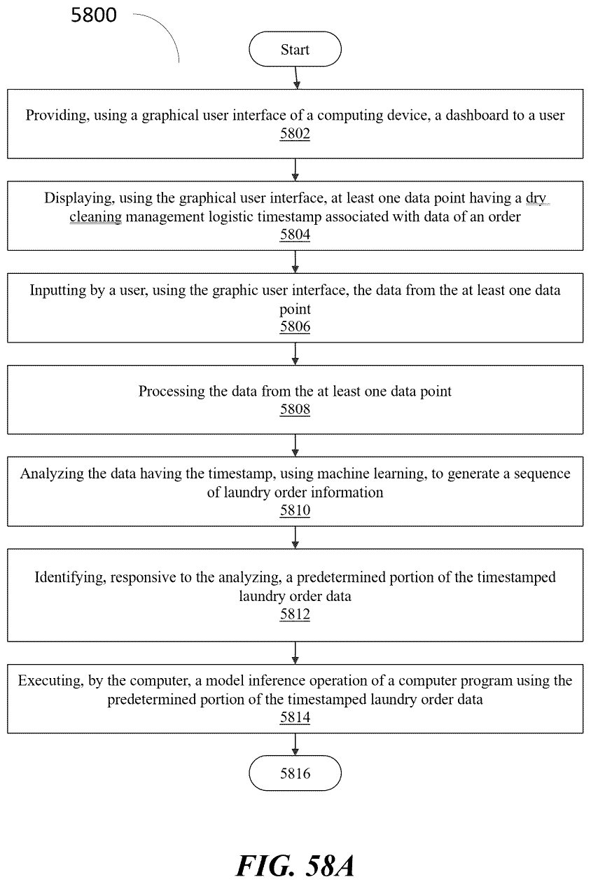

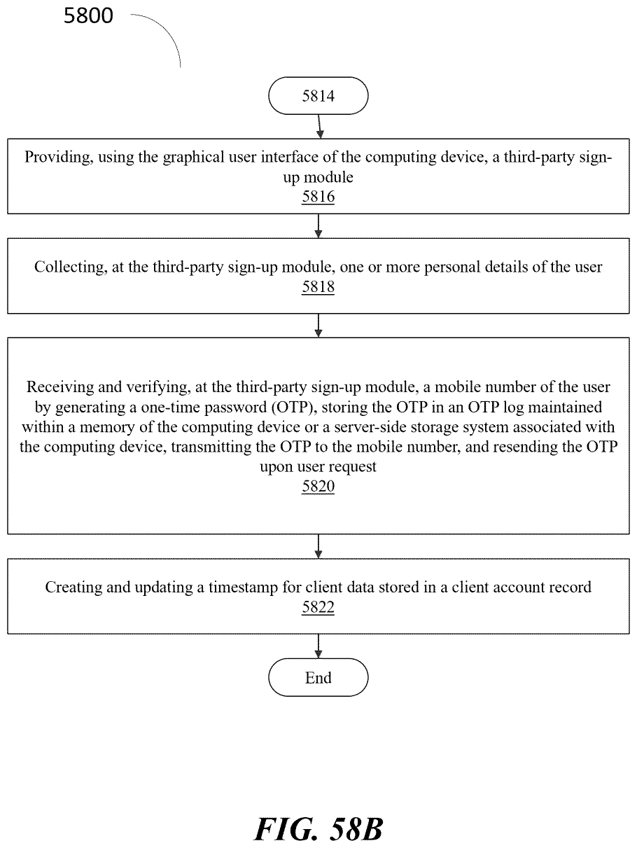

FIGS. 58A and 58B illustrate an example method 5800 executed by one or more processors of a computing device. At block 5802, the method begins by providing, through a graphical user interface of the computing device, a dashboard to a user. The dashboard may present operational metrics, order summaries, processing queues, or workflow controls associated with dry cleaning operations. At block 5804, the computing device displays at least one data point that includes a dry cleaning management logistic timestamp associated with an order. The timestamp may correspond to the order's creation time, pickup time, processing time, or delivery time, and may be expressed in formats such as UNIX time, epoch time, or ISO-formatted time strings.

At block 5806, the user inputs data related to the displayed data point through the graphical user interface, and the computing device receives this user-entered information. The user input may include changes to order details, status updates, corrections, or additional service parameters. At block 5808, the computing device processes the data from the user, including validating the input, normalizing formats, resolving conflicts with existing records, and storing the processed data for later use.

At block 5810, the computing device analyzes the timestamped data using one or more machine learning models to generate a sequence of laundry order information comprising timestamped laundry order data. The computing device may construct the sequence by ordering historical and real-time records according to their timestamps, removing duplicates, resolving incomplete entries, and deriving supplemental analytical features such as order frequency, customer recurrence, and revenue contributions.

At block 5812, the computing device identifies a predetermined portion of the timestamped laundry order data. The predetermined portion may include a machine-selected subset of the full sequence that meets selection criteria encoded in the program, such as a defined time window and a minimum number of records. The system may compute statistics, similarity measures, and recency weighting values to determine whether the candidate portion satisfies the programmed conditions for trend prediction. The predetermined portion therefore constitutes a computationally validated subset of the timestamped laundry order data used for subsequent inference.

At block 5814, the computing device executes a model inference operation of a computer program using the predetermined portion of the timestamped laundry order data. Executing the model inference operation may involve generating feature vectors from the predetermined portion, loading parameters of a trained machine learning model, and applying the trained model to generate predicted trends such as order frequency estimates, projected revenue, or anticipated demand patterns. The inference may use neural network models, tree-based models, or ensemble models deployed in optimized runtime environments.

At block 5816, the computing device provides, within the graphical user interface, a third-party sign-up module. The sign-up module may include a software-based registration interface rendered as part of the user interface, and the registration interface may contain programmatic elements configured to collect user information. At block 5818, the computing device receives one or more personal details of the user at the third-party sign-up module, including at least a full name, an email address, and a password entered into input fields of the registration interface.

At block 5820, the computing device receives and verifies a mobile number of the user by generating a one-time password and storing the generated password in an OTP log. The OTP log may be maintained within memory of the computing device or in a server-side storage system associated with the computing device. The computing device transmits the generated one-time password to the user's mobile number and resends the password if the user requests another verification code. The OTP log may store timestamps and verification metadata to maintain a record of verification attempts.

At block 5822, the computing device creates and updates a timestamp for client data that is stored in a client account record. The stored client data may include the personal details, address details, and payment card information collected and saved through the third-party sign-up module. The computing device may maintain timestamps indicating when the client data was created, modified, or verified, and may use these timestamps during future authentication, account management, or transaction processing operations.

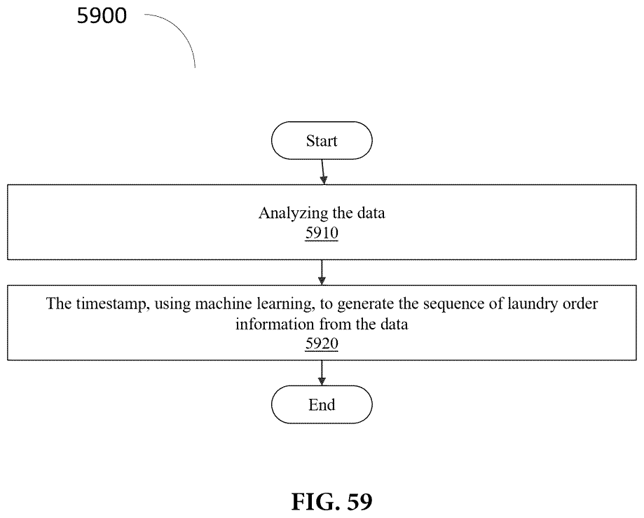

FIG. 59 illustrates an example method 5900 performed by one or more processors of a computing device for analyzing timestamped laundry-order data and generating a sequence of laundry-order information. At block 5910, the computing device analyzes the data associated with one or more laundry orders. The analyzed data may include, for each order, a timestamp that indicates creation time, pickup time, processing time, delivery time, or other dry-cleaning management events, along with associated attributes such as service type, pricing, weight, payment status, and location identifiers. The computing device may normalize the timestamps into a consistent format, remove erroneous or incomplete entries, correct out-of-sequence records, and convert categorical order information into machine-processable encodings. During this analysis, the computing device may also generate intermediate analytical values, such as order-count intervals, event-frequency indicators, or time-aligned data points spanning minutes, hours, days, or weeks of operational activity.

At block 5920, the computing device uses the timestamp information, processed in block 5910, together with one or more machine-learning operations, to generate a sequence of laundry-order information from the data. The sequence may be constructed by arranging the timestamped records in chronological order and applying a trained model to evaluate patterns or relationships in the ordering, timing, or attributes of the data. In some embodiments, the computer applies feature-extraction techniques to derive lagged values, moving-window aggregates, trend indicators, or other structured representations that characterize the timestamped order behavior. The machine-learning model may comprise a regression model, a neural network, a boosted-tree ensemble, or another predictive technique configured to interpret the temporal characteristics of the timestamped data. The generated sequence may therefore include an ordered collection of timestamp-indexed entries suitable for downstream prediction tasks such as identifying a predetermined portion of the timestamped laundry-order data or performing inference using the predetermined portion. Once the sequence has been generated at block 5920, the method 5900 may conclude.

### Additional Information

A list or reports include, but are not limited to, orders, clients, dry cleaning, alterations, wash and fold, sign up, pay later, what is in store, pick-up, dropped off by customer, items to be delivered to the store, and/or items to be picked up by a customer. Each report is displayed in the list of columns in the application. The cards are displayed. The associated graph is displayed, search functionality and pagination to be added, the report is downloadable in Excel, the report is printable, and/or the data is sorted using a filter. FORMULAS FOR REPORTS
1. Monthly Average Order Value: Show the list of all reports on click on which individual reports should open Total revenue in that month/Total number of orders in that month such as: $21,000/1000=$21
2. Total number of orders placed by the customer from start till current date
3. Average Monthly Sale: Total revenue in that year/12 (number of months in one year)
4. Individual Report for every customer:
   a. Number of orders placed
   b. Percentage of items in the order
Example 1. Percentage of pants—Num of pants/Total num of items in that order*100
Example 2. Percentage of shirts-Num of shirts/Total num of items in that order*100
5. Total Revenue Orders-Total order price for current month
6. Unpaid Orders−Till date (From beginning till today)
7. Orders Today−Total paid+unpaid orders
8. New clients this month. (New signups) NOTE:
The aforementioned steps 5, 6, 7, and 8 are from a figma file.
Total Revenue Orders−Total Revenue Orders (in current month)
Unpaid Orders−Unpaid Orders (Till Date)
Orders Today−Orders Today (Paid+Unpaid)

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

In some embodiments, the system includes an AI-enabled prediction logic that provides a specific improvement to computer functionality by transforming raw, timestamped POS transaction streams into structured, machine-processable data windows through a sequence of enforced computational constraints. The system does not simply perform mental steps or generic data analysis; instead, it implements a modified data-handling architecture that restructures unbounded and irregular POS event logs into a deterministic, ordered time-series buffer optimized for machine-learning inference. This architecture improves the functioning of the POS computing environment by reducing latency, preventing data collisions, enforcing temporal integrity, and generating prediction outputs that were not previously achievable using conventional POS systems or human analysis.

In some embodiments, each order record is ingested into a specialized chronological transaction buffer that imposes strict ordering and validation rules designed to prevent out-of-sequence writes and data corruption. The buffer maintains temporal integrity even when the POS network experiences packet delay, jitter, or partial record transmission. By enforcing monotonic timestamp ordering and anomaly-detection filters at the point of ingestion, the system materially improves the accuracy and reliability of downstream computational operations. This preprocessing approach constitutes a data-structure-level improvement to the computer itself, because the system creates a modified time-series data structure that cannot be constructed through ordinary human activity or general business practice.

In operation, the system continuously monitors the incoming POS data stream and identifies a predetermined portion of timestamped records according to technical processing rules that must be satisfied before model inference can occur. These rules include a dynamic sliding-window constraint of four to six weeks, a minimum transaction-volume threshold to ensure numerical stability, a recency-weighted exponential decay function applied to the data to suppress noise, and a seasonal-pattern validation step requiring a similarity score above a predetermined threshold. These steps constitute machine-enforced gating conditions that constrain when and how data is considered usable. Such gating conditions are not mental processes, nor can they be carried out manually; they require continuous computation, statistical evaluation, array-level manipulation, and similarity scoring performed over thousands of timestamp-synchronized data points, which improves the computer's ability to process time-dependent data in real time.

Once the predetermined portion is selected, the system normalizes the values and generates derivative metrics such as rolling variances, lagged historical values, and multi-period aggregates. These transformations are produced using vectorized operations that reorganize and reweight the raw transaction logs into multidimensional feature matrices optimized for machine-learning inference. This feature-engineering pipeline is implemented at the system level and functions as a technical improvement, because it replaces previously inefficient batch-based analytics with a continuous, low-latency computation model that enhances the speed, reliability, and predictive capabilities of the underlying POS infrastructure.

In some embodiments, the system invokes a hybrid ensemble of machine-learning models that execute within an optimized inference runtime container distinct from the training pipeline. The inference layer uses specialized execution engines, such as ONNX-or TensorRT-compatible modules, which accelerate tensor operations, optimize memory access patterns, and reduce processor overhead. By deploying the models in these specialized containers, the system improves the computer's inference throughput, reduces execution latency, and avoids computational bottlenecks associated with conventional model invocation. This constitutes a technical improvement to the computer system itself, not merely an abstract idea, because the system modifies the way the hardware processes model execution requests and data tensors.

During post-processing, the system aggregates the raw inference outputs into structured prediction layers that compute confidence intervals, detect anomalies, align predictions with historical baselines, and perform multilevel segmentation by POS location, geography, and service type. These operations require matrix decomposition, variance modeling, and signal-alignment validation, none of which can be reasonably performed by human operators without undue burden. By performing these computations in a single, unified execution pipeline, the system materially improves the speed and accuracy with which the computing device derives actionable insights from large-scale, timestamped POS datasets.

In some embodiments, the system includes a continuous-learning module that retrains the prediction models at periodic intervals and monitors model drift by computing accuracy decay metrics. This module implements automated triggers that perform revalidation and retraining when model performance drops below a threshold. This adaptive maintenance system improves the computer's operation by enabling it to recognize and respond to data-distribution shifts that conventional POS computing systems cannot detect. The continuous-learning functionality ensures that the prediction engine remains computationally efficient, stable, and resilient to changes in transaction volume and customer behavior.

Across these embodiments, the AI prediction logic produces specific, technologically grounded output, including revenue forecasts, anomaly alerts, confidence scores, and feature-importance mappings, that are generated only after the computer applies the specialized data-structuring, gating, inferencing, and post-processing techniques described herein. The system therefore does not merely automate a business practice; instead, it implements a particular sequence of technical operations that improve the functioning of the computer itself through enhanced data ordering, constrained window selection, optimized model execution, and real-time analytic computation. These improvements allow the computing device to handle high-velocity POS transactions at scale, maintain prediction stability, and generate actionable forecasting outputs that were previously infeasible using traditional software systems.

The disclosed system provides multiple technical benefits that enhance the operation of computing devices used within point-of-sale environments. In some embodiments, the system improves computer functionality by converting raw, irregular POS transaction streams into ordered, deterministic data structures that are suitable for machine-level processing. By transforming unbounded event logs into structured, machine-processable time-series windows, the system reduces processing latency, mitigates data-collision events, and preserves temporal integrity across distributed POS networks. These improvements yield more reliable downstream computations and enable forms of real-time data analysis that conventional POS systems cannot perform.

The system also provides technical benefits through the use of a chronological transaction buffer that enforces monotonic ordering and validates timestamp correctness at ingestion. This buffer prevents out-of-sequence writes, compensates for network jitter, and guards against partial or corrupted data packets. As a result, the computing device maintains accurate temporal alignment between related transactions, improving the fidelity of all subsequent analytical and machine-learning operations. The resulting data structure cannot be produced manually and enhances overall system reliability by reducing the risk of computational errors caused by inconsistent temporal data.

Further technical benefits arise from the system's continuous monitoring of incoming POS data and the identification of predetermined data windows using machine-enforced criteria. These criteria include sliding-window selection, transaction-volume thresholds, recency-weighted decay functions, and seasonal-pattern validation. By enforcing these gating conditions through automated, high-frequency computation, the system improves the computer's ability to process time-dependent data and ensures that only statistically meaningful data segments are used for prediction. This level of automated data conditioning enables reliable real-time forecasting and reduces the computational load associated with processing full historical datasets.

Additional technical benefits are provided by the system's feature-engineering pipeline, which generates rolling variances, lagged correlations, multi-period aggregates, and vectorized feature matrices. These transformations optimize the data for machine-learning inference and replace inefficient batch analytics with a continuous, low-latency processing model. This architecture improves both the throughput and responsiveness of the POS computing environment by reducing memory overhead and accelerating data-preparation stages that would otherwise limit system performance.

In some embodiments, the system improves inference efficiency through the use of optimized model-execution containers such as ONNX-or TensorRT-based runtimes. These runtimes accelerate tensor operations, reduce memory-access latency, and minimize processor bottlenecks during execution of hybrid machine-learning ensembles. This results in faster forecasting, reduced resource consumption, and improved support for large-scale, real-time inference workloads within POS networks. These benefits arise from modifications to the manner in which the computer executes model computations and are not achievable through ordinary software execution paths.

During post-processing, the system provides additional technical benefits by aggregating predictions into structured output layers that perform confidence-interval computation, anomaly detection, and multilevel segmentation across locations and service categories. These operations rely on automated matrix decomposition, statistical variance modeling, and signal-alignment evaluation, all of which reduce the computational burden on human operators and enable the computer to derive actionable insights directly from large-scale, timestamped datasets. This unified processing pipeline improves analytical accuracy and reduces the likelihood of human error during interpretation of POS performance data.

The system further improves computer operation through a continuous-learning module that detects accuracy drift and retrains machine-learning models when necessary. This automated maintenance capability enables the computer to adapt to changing data distributions, transaction volumes, and customer-behavior patterns without manual intervention. By dynamically updating the model parameters, the system maintains predictive stability and prevents degradation in forecasting performance, improving long-term computational efficiency and robustness.

Across these embodiments, the system provides technical benefits by enhancing data handling, improving temporal ordering, increasing model-execution efficiency, and supporting scalable real-time forecasting. These improvements enable computing devices operating in POS environments to process high-velocity transactional data with greater stability and accuracy, resulting in forecasting capabilities that are not attainable through traditional software architectures or manual analytic methods.

### EXAMPLES

Embodiment 1. A computer program comprising instructions which, when the program is executed by a computer, cause the computer to carry out the steps of: providing, using a graphical user interface of a computing device, a dashboard to a user; displaying, using the graphical user interface, at least one data point having a laundry management logistic timestamp associated with data of an order; inputting by the user, using the graphical user interface, the data from the at least one data point; processing the data from the at least one data point; analyzing the data having the timestamp, using machine learning, to generate a sequence of laundry order information comprising timestamped laundry order data; identifying, responsive to the analyzing, a predetermined portion of the timestamped laundry order data, the predetermined portion comprising a machine selected subset of the sequence that satisfies one or more selection criteria including a defined time window of recent timestamped laundry order data and a minimum quantity of records; executing, by the computer, a model inference operation of the computer program using the predetermined portion of the timestamped laundry order data, wherein executing the computer program on the predetermined portion comprises applying a trained machine learning model to the predetermined portion to generate predicted trends; providing, using the graphical user interface of the computing device, a third-party sign-up module comprising a software based registration interface rendered within the graphical user interface, wherein the registration interface includes programmatic elements configured to collect user account information; collecting, at the third-party sign-up module, one or more personal details of the user including at least a full name, an email address, and a password entered into user input fields of the registration interface; receiving and verifying, at the third-party sign-up module, a mobile number of the user by generating a one-time password (OTP), storing the OTP in an OTP log maintained within a memory of the computing device or a server side storage system associated with the computing device, transmitting the OTP to the mobile number, and resending the OTP upon user request; and creating and updating a timestamp for client data stored in a client account record, wherein the client data includes at least personal details, address details, and payment card information collected and saved by the third-party sign-up module.

Embodiment 2. The computer program of embodiment 1, further comprising generating, using the machine learning, a model of the trend.

Embodiment 3. The computer program of embodiment 1, further comprising displaying, using the graphical user interface, a graph having data associated with the trend for order rate.

Embodiment 4. The computer program of embodiment 1, further comprising displaying, using the graphical user interface, a graph having data associated with the trend for income.

Embodiment 5. The computer program of embodiment 1, further comprising displaying, using the graphical user interface, a graph having data associated with the trend for order frequency.

Embodiment 6. The computer program of embodiment 1, further comprising displaying, using the graphical user interface, a chart having data associated with the trend for a percentage calculated of a laundry order item for a predetermined time.

Embodiment 7. The computer program of embodiment 1, further comprising displaying, using the graphical user interface, a chart having data associated with the trend for a percentage calculated of a payment method used for a laundry order item. Embodiment 8. The computer program of embodiment 1, further comprising generating, using a report module, a report.

Embodiment 9. The computer program of embodiment 8, wherein the report is an individual report for a customer based on a quantity of orders placed in a predetermined time period and a percentage of items in the order for the predetermined time period.

Embodiment 10. The computer program of embodiment 8, wherein the report is a monthly average order value report for the user based on a total revenue in a predetermined time period and a quantity of orders placed in the predetermined time period.

Embodiment 11. A computer-implemented method comprising: providing, using a graphical user interface of a computing device, a dashboard to a user; displaying, using the graphical user interface, at least one data point having a dry cleaning management logistic timestamp associated with data of an order; inputting by a user, using the graphic user interface, the data from the at least one data point; processing the data from the at least one data point; analyzing the data having the timestamp, using machine learning, to generate a sequence of laundry order information comprising timestamped laundry order data; identifying, responsive to the analyzing, a predetermined portion of the timestamped laundry order data, the predetermined portion comprising a machine selected subset of the sequence that satisfies one or more selection criteria including a defined time window of recent timestamped laundry order data and a minimum quantity of records; executing, by the computer, a model inference operation of a computer program using the predetermined portion of the timestamped laundry order data, wherein executing the computer program on the predetermined portion comprises applying a trained machine learning model to the predetermined portion to generate predicted trends; providing, using the graphical user interface of the computing device, a third-party sign-up module comprising a software based registration interface rendered within the graphical user interface, wherein the registration interface includes programmatic elements configured to collect user account information; collecting, at the third-party sign-up module, one or more personal details of the user including at least a full name, an email address, and a password entered into user input fields of the registration interface; receiving and verifying, at the third-party sign-up module, a mobile number of the user by generating a one-time password (OTP), storing the OTP in an OTP log maintained within a memory of the computing device or a server side storage system associated with the computing device, transmitting the OTP to the mobile number, and resending the OTP upon user request; and creating and updating a timestamp for client data stored in a client account record, wherein the client data includes at least personal details, address details, and payment card information collected and saved by the third-party sign-up module.

Embodiment 12. The computer-implemented method of embodiment 11, further comprising displaying, using the graphical user interface, a graph having data associated with the trend for order rate.

Embodiment 13. The computer-implemented method of embodiment 11, further comprising displaying, using the graphical user interface, a graph having data associated with the trend for income.

Embodiment 14. The computer-implemented method of embodiment 11, further comprising displaying, using the graphical user interface, a graph having data associated with the trend for order frequency.

Embodiment 15. The computer-implemented method of embodiment 11, further comprising displaying, using the graphical user interface, a chart having data associated with the trend for a percentage calculated of a dry cleaning order item for a predetermined time.

Embodiment 16. The computer-implemented method of embodiment 11, further comprising displaying, using the graphical user interface, a chart having data associated with the trend for a percentage calculated of a payment method used for a dry cleaning order item.

Embodiment 17. The computer-implemented method of embodiment 11, further comprising generating, using a report module, a report.

Embodiment 18. The computer-implemented method of embodiment 17, wherein the report is an individual report for a customer based on a quantity of orders placed in a predetermined time period and a percentage of items in the order for the predetermined time period.

Embodiment 19. The computer-implemented method of embodiment 17, wherein the report is a monthly average order value report for a user based on a total revenue in a predetermined time period and a quantity of orders placed in the predetermined time period.

Embodiment 20. The computer-implemented method of embodiment 11. further comprising analyzing the data having the timestamp, using machine learning, to generate the sequence of laundry order information from the data having the timestamp.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer program comprising instructions which, when the program is executed by a computer, cause the computer to carry out the steps of:
providing, using a graphical user interface of a computing device, a dashboard to a user;
displaying, using the graphical user interface, at least one data point having a laundry management logistic timestamp associated with data of an order;
inputting by the user, using the graphical user interface, the data from the at least one data point;
processing the data from the at least one data point;
analyzing the data having the timestamp, using machine learning, to generate a sequence of laundry order information comprising timestamped laundry order data;
identifying, responsive to the analyzing, a predetermined portion of the timestamped laundry order data, the predetermined portion comprising a machine selected subset of the sequence that satisfies one or more selection criteria including a defined time window of recent timestamped laundry order data and a minimum quantity of records;
executing, by the computer, a model inference operation of the computer program using the predetermined portion of the timestamped laundry order data, wherein executing the computer program on the predetermined portion comprises applying a trained machine learning model to the predetermined portion to generate predicted trends;
providing, using the graphical user interface of the computing device, a third-party sign-up module comprising a software based registration interface rendered within the graphical user interface, wherein the registration interface includes programmatic elements configured to collect user account information;
collecting, at the third-party sign-up module, one or more personal details of the user including at least a full name, an email address, and a password entered into user input fields of the registration interface;
receiving and verifying, at the third-party sign-up module, a mobile number of the user by generating a one-time password (OTP), storing the OTP in an OTP log maintained within a memory of the computing device or a server side storage system associated with the computing device, transmitting the OTP to the mobile number, and resending the OTP upon user request; and
creating and updating a timestamp for client data stored in a client account record, wherein the client data includes at least personal details, address details, and payment card information collected and saved by the third-party sign-up module.

2. The computer program of claim 1, further comprising generating, using the machine learning, a model of the trend.

3. The computer program of claim 1, further comprising displaying, using the graphical user interface, a graph having data associated with the trend for order rate.

4. The computer program of claim 1, further comprising displaying, using the graphical user interface, a graph having data associated with the trend for income.

5. The computer program of claim 1, further comprising displaying, using the graphical user interface, a graph having data associated with the trend for order frequency.

6. The computer program of claim 1, further comprising displaying, using the graphical user interface, a chart having data associated with the trend for a percentage calculated of a laundry order item for a predetermined time.

7. The computer program of claim 1, further comprising displaying, using the graphical user interface, a chart having data associated with the trend for a percentage calculated of a payment method used for a laundry order item.

8. The computer program of claim 1, further comprising generating, using a report module, a report.

9. The computer program of claim 8, wherein the report is an individual report for a customer based on a quantity of orders placed in a predetermined time period and a percentage of items in the order for the predetermined time period.

10. The computer program of claim 8, wherein the report is a monthly average order value report for the user based on a total revenue in a predetermined time period and a quantity of orders placed in the predetermined time period.

11. A computer-implemented method comprising:
providing, using a graphical user interface of a computing device, a dashboard to a user;
displaying, using the graphical user interface, at least one data point having a dry cleaning management logistic timestamp associated with data of an order;
inputting by a user, using the graphic user interface, the data from the at least one data point;
processing the data from the at least one data point;
analyzing the data having the timestamp, using machine learning, to generate a sequence of laundry order information comprising timestamped laundry order data;
identifying, responsive to the analyzing, a predetermined portion of the timestamped laundry order data, the predetermined portion comprising a machine selected subset of the sequence that satisfies one or more selection criteria including a defined time window of recent timestamped laundry order data and a minimum quantity of records;
executing, by the computer, a model inference operation of a computer program using the predetermined portion of the timestamped laundry order data, wherein executing the computer program on the predetermined portion comprises applying a trained machine learning model to the predetermined portion to generate predicted trends;
providing, using the graphical user interface of the computing device, a third-party sign-up module comprising a software based registration interface rendered within the graphical user interface, wherein the registration interface includes programmatic elements configured to collect user account information;
collecting, at the third-party sign-up module, one or more personal details of the user including at least a full name, an email address, and a password entered into user input fields of the registration interface;
receiving and verifying, at the third-party sign-up module, a mobile number of the user by generating a one-time password (OTP), storing the OTP in an OTP log maintained within a memory of the computing device or a server side storage system associated with the computing device, transmitting the OTP to the mobile number, and resending the OTP upon user request; and
creating and updating a timestamp for client data stored in a client account record, wherein the client data includes at least personal details, address details, and payment card information collected and saved by the third-party sign-up module.

12. The computer-implemented method of claim 11, further comprising displaying, using the graphical user interface, a graph having data associated with the trend for order rate.

13. The computer-implemented method of claim 11, further comprising displaying, using the graphical user interface, a graph having data associated with the trend for income.

14. The computer-implemented method of claim 11, further comprising displaying, using the graphical user interface, a graph having data associated with the trend for order frequency.

15. The computer-implemented method of claim 11, further comprising displaying, using the graphical user interface, a chart having data associated with the trend for a percentage calculated of a dry cleaning order item for a predetermined time.

16. The computer-implemented method of claim 11, further comprising displaying, using the graphical user interface, a chart having data associated with the trend for a percentage calculated of a payment method used for a dry cleaning order item.

17. The computer-implemented method of claim 11, further comprising generating, using a report module, a report.

18. The computer-implemented method of claim 17, wherein the report is an individual report for a customer based on a quantity of orders placed in a predetermined time period and a percentage of items in the order for the predetermined time period.

19. The computer-implemented method of claim 17, wherein the report is a monthly average order value report for a user based on a total revenue in a predetermined time period and a quantity of orders placed in the predetermined time period.

20. The computer-implemented method of claim 11, further comprising analyzing the data having the timestamp, using machine learning, to generate the sequence of laundry order information from the data having the timestamp.
